(19) United States
(12) Patent Application Publication
(10) Pub. No.: US 2023/0040461 A1
(43) Pub. Date: Feb. 9, 2023

(54) TONER, DEVELOPER, IMAGE FORMING METHOD, IMAGE FORMING APPARATUS, AND TONER STORAGE UNIT

(71) Applicants: Daisuke Inoue, Shizuoka (JP); Mitsuaki Hirose, Shizuoka (JP); Yohichi Kitagawa, Shizuoka (JP); Tsukiko Takahashi, Shizuoka (JP); Kenji Komito, Tokyo (JP); Akihiko Moki, Kanagawa (JP)

(72) Inventors: Daisuke Inoue, Shizuoka (JP); Mitsuaki Hirose, Shizuoka (JP); Yohichi Kitagawa, Shizuoka (JP); Tsukiko Takahashi, Shizuoka (JP); Kenji Komito, Tokyo (JP); Akihiko Moki, Kanagawa (JP)

(73) Assignee: Ricoh Company, Ltd., Tokyo (JP)

(21) Appl. No.: 17/814,644

(22) Filed: Jul. 25, 2022

(30) Foreign Application Priority Data
Jul. 29, 2021 (JP) 2021-124279

(51) Int. Cl. G03G 9/097; G03G 9/08; G03G 9/087; G03G 15/08

(52) U.S. Cl. CPC G03G 9/09716; G03G 9/0827; G03G 9/0821; G03G 9/0819; G03G 9/08755; G03G 15/0865

(57) ABSTRACT

A toner includes: toner base particles including a binder resin, a colorant, an inorganic filler, and a release agent; and an external additive. An average circularity of the toner is 0.974 or more but 0.985 or less. A surface roughness parameter Sz of a surface of the toner is 200 nm or more but 500 nm or less, the surface roughness parameter Sz being measured with an atomic force microscope (AFM).

### CROSS-REFERENCE TO RELATED APPLICATIONS

The present application claims priority under 35 U.S.C. § 119 to Japanese Patent Application No. 2021-124279 filed Jul. 29, 2021. The contents of which are incorporated herein by reference in their entirety.

### BACKGROUND OF THE INVENTION

### Field of the Invention

The present disclosure relates to a toner, a developer, an image forming method, an image forming apparatus, and a toner storage unit.

### Description of the Related Art

In recent years, in the field of the electrophotographic image forming technique, images can be formed at a high speed, and competition for development of color image forming apparatuses that enable high image quality has intensified. Therefore, in order to obtain full color images at a high speed, so-called the tandem system, in which a plurality of electrophotographic photoconductors are arranged in series in an image forming method, an image for a color component is formed in each of the electrophotographic photoconductors, and the images are superimposed on an intermediate transfer member and are transferred to a recording medium at one time, has been widely employed (see, for example, Japanese Unexamined Patent Application Publication No. 07-209952 and Japanese Unexamined Patent Application Publication No. 2000-075551).

On the other hand, full color image formation with high image quality has been demanded, and developers that achieve high image quality have been designed. In order to meet a demand for high image quality, particularly, full color image quality, the toner particle diameter is becoming smaller and smaller, and faithful reproduction of latent images has been considered. Regarding this particle diameter reduction, as a means for being capable of toner control to achieve desired shapes and surface structures, the toner production method using the polymerization method has been proposed (see, for example, Japanese Patent No. 3640918 and Japanese Unexamined Patent Application Publication No. 09-96965). A toner produced by the polymerization method can achieve controlled particle diameters and controlled shapes of the toner particles. In addition to this, when the particle diameter is smaller, reproducibility of dots or thin lines can increase, and pile height (thickness of image layers) can decreases. Therefore, higher image quality can be expected.

As a means for controlling cleanability, control of toner shapes has been proposed. When the toner shape is controlled to a deformed shape, not a spherical shape, an effect of preventing a toner from slipping through on a cleaning member can be obtained (see, for example, Japanese Unexamined Patent Application Publication No. 2005-037892).

Japanese Unexamined Patent Application Publication No. 2006-184746 describes that when the depth and the frequency of wrinkles on the toner surface are controlled, a lower deposition amount and high transferability are achieved. The toner described in Japanese Unexamined Patent Application Publication No. 2006-184746 has many wrinkles having a depth of 500 nm or more and has a cleanability.

Japanese Unexamined Patent Application Publication No. 2005-274763 provides good charging ability and transferability of a toner for a long period of time by controlling the surface shapes of a toner and a carrier.

### SUMMARY OF THE INVENTION

According to one aspect of the present disclosure, a toner includes: toner base particles including a binder resin, a colorant, an inorganic filler, and a release agent; and an external additive. An average circularity of the toner is 0.974 or more but 0.985 or less. A surface roughness parameter Sz of a surface of the toner is 200 nm or more but 500 nm or less, the surface roughness parameter Sz being measured with an atomic force microscope (AFM).

### BRIEF DESCRIPTION OF THE DRAWINGS

FIG. 1 is a schematic configuration view illustrating an example of an image forming apparatus of the present disclosure:

FIG. 2 is a schematic configuration view illustrating another example of the image forming apparatus of the present disclosure;

FIG. 3 is a schematic configuration view illustrating another example of the image forming apparatus of the present disclosure;

FIG. 4 is a partial enlarged view of FIG. 3; and

FIG. 5 is a schematic configuration view illustrating an example of a process cartridge.

### DESCRIPTION OF THE EMBODIMENTS

The toner, developer, image forming apparatus, image forming method, and toner storage unit of the present disclosure will be described below with reference to the drawings. The present disclosure is not limited to the embodiments shown below, and other embodiments, additions, modifications, deletions, etc. are possible within the scope that is conceivable by those skilled in the art. Any embodiment shall be included within the scope of the present disclosure as long as the action and effect of the present disclosure can be achieved.

### (Toner)

A toner according to the present disclosure includes toner base particles including a binder resin, a colorant, an inorganic filler, and a release agent; and an external additive. An average circularity of the toner base particles is 0.974 or more but 0.985 or less, and a surface roughness parameter Sz of a surface of the toner is 200 nm or more but 500 nm or less, the surface roughness parameter Sz being measured with an atomic force microscope (AFM).

The average circularity is preferably 0.978 or more but 0.982 or less, and the surface roughness parameter Sz of the toner surface is preferably 300 nm or more but 400 nm or less.

The average circularity of the toner is determined depending on the shape of the toner base particles, but there is no difference between the average circularity of the toner base particles measured and the average circularity of the toner measured.

The intermediate transfer members in Japanese Unexamined Patent Application Publication No. 07-209952 and Japanese Unexamined Patent Application Publication No. 2000-075551 have an effect of preventing background fog from being directly transferred to a recording material such as paper when the background fog occurs on an electrophotographic photoconductor at the time of developing. However, a method using the intermediate transfer member decreases transfer efficiency because the method experiences two transfer steps: a transfer step (primary transfer) from an electrophotographic photoconductor to an intermediate transfer member; and a transfer step (secondary transfer) from the intermediate transfer member to a recording medium to obtain a final image.

Japanese Patent No. 3640918 and Japanese Unexamined Patent Application Publication No. 9-96965 describe problems that when a spherical toner is used, a defective image caused due to cleaning failure occurs easily in a cleaning method using a cleaning blade by which a blade formed of an elastic member is pressed against an image bearer to remove a toner or a cleaning roller method by which a roller formed of an elastic material is pressed against an image bearer and is rotated to remove a toner.

Japanese Unexamined Patent Application Publication No. 2005-037892 describes that a deformed toner increases the contact area between the image bearer and the toner compared to a spherical toner, adhesion between the image bearer and the toner increases, and the toner adhering on the surface of the image bearer is not easily transferred, resulting in decreased transfer efficiency.

Japanese Unexamined Patent Application Publication No. 2006-184746 describes that many wrinkles with a depth of 500 nm or more undeniably decrease transferability, exhibiting poor transfer efficiency.

Japanese Unexamined Patent Application Publication No. 2005-274763 describes that occurrence of cleaning failure can be easily expected particularly over time because the unevenness is too small to scrape a toner using a cleaning blade.

As a mechanism for transferring a toner from an electrostatic charge holder to a transfer material, in order to reduce ozone generation for environmental consideration, the contact-type transfer device, in which a transferring unit abuts against part of an electrostatic charge holder via a transfer material and a toner image is electrostatically transferred to the surface of a transfer material, has been increasingly employed from the noncontact-type transfer device using corona discharge that generates a large amount of ozone.

This contact transfer method easily achieves close adhesiveness between a transfer material and an electrostatic charge holder, and easily obtain a transfer image with high quality.

However, when the abutting pressure is applied, the pressure is also applied to a toner image on the electrostatic charge holder, which aggregates the toner. As a result, an adhesive force with the electrostatic charge holder increases, and the transferability decreases drastically. It is found that the contact transfer method depends largely on the shape of a toner. As a toner is more spherical, the contact area between the toner and the transfer material and the contact area between the toner and the electrostatic charge holder decrease, improving transferability. When the average circularity of the toner is less than 0.974, the contact area between the toner and the transfer material and the contact area between the toner and the electrostatic charge holder increase, failing to obtain sufficient transferability.

The cleaning system using a cleaning blade to remove a toner by pressing a blade formed of an elastic material against an image bearer and the cleaning roller system to remove a toner by pressing and rotating a roller formed of an elastic material against an image bearer have a problem that image failure caused due to cleaning failure occurs easily. When the average circularity of the toner is more than 0.985, the toner rotates easily because of no friction between the cleaning blade and the toner in the cleaning nip, and the toner slips through the blade, causing cleaning failure.

The toner of the present disclosure controls unevenness on the surface of the toner and adjusts friction conditions between the cleaning blade and the toner. Therefore, the toner of the present disclosure can secure cleanability even when it has a spherical shape. When the surface roughness parameter Sz on the surface of the toner is less than 200 nm, the toner rotates easily because of no friction between the cleaning blade and the toner, and slips through the blade, causing cleaning failure. On the other hand, the surface roughness parameter Sz on the surface of the toner is more than 500 nm, the contact area between the toner and the transfer material and the contact area between the toner and the electrostatic charge holder increase, which fails to obtain sufficient transferability.

The present disclosure is made in view of the above problems and has an object to provide a toner that can maintain a toner that can maintain excellent cleanability and transfer efficiency.

According to the present disclosure, it is possible to provide a toner that can maintain excellent cleanability and transfer efficiency.

In terms of image quality and resolution, the toner advantageously has a smaller volume average particle diameter Dv, and preferably has a volume average particle diameter Dv of less than 6.0 μm. On the other hand, when the volume average particle diameter Dv of the toner is small, a non-electrostatic adhesive force increases, and the toner easily slips through on a cleaning blade, decreasing cleanability. Therefore, the volume average particle diameter Dv is preferably 4.0 μm or more.

It is known that cleaning becomes difficult as the shape of the toner is closer to a spherical shape. As a result of intensive studies, on the other hand, it is found that imparting unevenness to the surface of the toner makes it possible to obtain good cleanability.

A method for controlling the unevenness on the surface of the toner is not particularly limited and may be appropriately selected depending on the intended purpose. For example, a method by which a deforming agent such as an inorganic filler or a layered inorganic mineral is unevenly distributed on the surface of the toner has been known.

The toner of the present disclosure controls the unevenness of the toner by controlling the arrangement of the inorganic filler on the surface of the toner. From a backscattered electron image taken with a scanning electron microscope, the arrangement of the inorganic filler can be observed. An exposure area ratio of the inorganic filler is preferably a relationship of 0.30≤S2/S1≤0.70, where the S1 is an area of toner base particles, and the S2 is a total area of the inorganic filler exposed to the surfaces of the toner base particles. The area of the toner base particles and the area of the inorganic filler can be determined from binarization of the backscattered electron image.

When the S2/S1 is 0.30 or more, such a problem that sufficient unevenness is not obtained due to a small area of the inorganic filler exposed can be overcome.

When the S2/S1 is 0.70 or less, such problems that unevenness becomes too large and fixability is prevented can be overcome.

A toner shape can be controlled by thixotropy of toner droplets in the polymerization method.

Preferably, the toner of the present disclosure includes a crystalline polyester, and the toner includes from 6% by parts through 12% by parts of the crystalline polyester in the toner. The crystalline polyester exists in the toner particles in a crystalline state. Therefore, when it is properly arranged, the state of the toner surface can be controlled.

### <Toner Base Particles>

The toner base particles of the present embodiment are particles including wide and deep concavities, and include a binder resin, a colorant, an inorganic filler, and a release agent. The toner base particles further can include other components (e.g., a flowability improving agent, a cleanability improving agent, a magnetic material, and a lubricant) according to the necessity.

### (Inorganic Filler)

The toner base particles of the present disclosure are produced by adding an inorganic filler to, for example, a binder resin, a colorant, and a release agent.

The inorganic filler is not particularly limited. One or more materials selected from, for example, calcium carbonate, kaolin clay, talc, and barium sulfate can be added alone or in combination. These inorganic fillers may be subjected to a surface treatment with, for example, a silane coupling agent, a surfactant, or a metallic soap. In addition, such a material that has a desired particle diameter distribution adjusted through, for example, classification may be used.

The inorganic filler included in the toner base particles of the present disclosure is preferably a layered inorganic mineral, and is more preferably a layered inorganic mineral deformed with organic ions.

The layered inorganic mineral refers to an inorganic mineral obtained by overlying layers with a thickness of several nanometers, and being modified with organic ions refers to introduction of organic ions into ions existing between the layers.

As the layered inorganic mineral, smectite (e.g., montmorillonite and saponite), kaolin (e.g., kaolinite), magadite, and kanemite are known. The layered inorganic mineral may be a synthetic mineral.

A modified layered inorganic mineral has a high hydrophilicity because of its modified layered structure. Therefore, when the layered inorganic mineral is dispersed in an aqueous medium without modifying the layered inorganic mineral and is used for a toner to be granulated, the layered inorganic mineral is transferred to the aqueous medium, which fails to deform the toner. Modifying the layered inorganic mineral results in a high hydrophilicity. Such a modified layered inorganic mineral is formed into fine particles and is deformed at the time of toner production, exists in large amounts particularly in the surfaces of the toner particles, and can be uniformly dispersed and arranged on the whole toner base particles. Therefore, modification of the layered inorganic mineral contributes to electric charge adjustment and low-temperature fixability. At this time, the amount of the modified layered inorganic mineral in the toner material is preferably 0.2% by mass or more but 1.5% by mass or less.

The modified layered inorganic mineral used in the present disclosure is desirably a material obtained by modifying one having a smectite-based basic crystal structure with organic cations. When part of a bivalent metal of the layered inorganic mineral is substituted with a trivalent metal, metallic anions can be introduced. However, it is desirable to use a layered inorganic compound obtained by modifying at least part of metallic anions with organic anions because introduction of metallic anions much increases hydrophilicity.

Examples of an organic ion modifier of the layered inorganic mineral obtained by modifying, with organic ions, at least part of ions included in the layered inorganic mineral include quaternary alkylammonium salts, phosphonium salts, and imidazolium salts, but quaternary alkylammonium salts are desirable. Examples of the quaternary alkylammonium salts include trimethylstearylammonium, dimethylstearylbenzylammonium, dimethyloctadecylammonium, and oleyl bis (2-hydroxyethyl) methylammonium.

Examples of the organic ion modifier include sulfates, sulfonates, carboxylates, and phosphates including, for example, branched, non-branched, or cyclic alkyl (C1-C44), alkenyl (C1-C22), alkoxy (C8-C32), hydroxyalkyl (C2-C22), ethylene oxide, and propylene oxide. Among them, carboxylic acid having an ethylene oxide skeleton is desirable.

When at least part of the layered inorganic mineral is modified with organic ions, an oil phase, which has an appropriate hydrophobicity and includes a toner composition and/or a toner composition precursor, can have a non-Newtonian viscosity and can deform a toner. At this time, an amount of the at least part of the layered inorganic mineral modified with organic ions in the toner material is preferably 0.2% by mass or more but 1.5% by mass or less.

The part of the layered inorganic mineral modified with organic ions can be appropriately selected. Examples thereof include montmorillonite, bentonite, hectorite, attapulgite, sepiolite, and mixtures thereof. Among them, montmorillonite or bentonite including an Al element is preferable because the Al element has effects of improving a charging ability.

Examples of commercially available products of the part of the layered inorganic mineral modified with organic cations include quaternium-18 bentonite such as Bentone 3, Bentone 38, and Bentone 38V (all of which are available from Rheox), TIXOGEL VP (available from United catalyst), and CLAYTONE 34, CLAYTONE 40, and CLAYTONE XL (all of which are available from Southern Clay); stearalkonium bentonite such as Bentone 27 (available from Rheox), TIXOGEL LG (available from United catalyst), and CLAYTONE AF and CLAYTONE APA (both of which are available from Southern Clay); and quaternium-18/benzalkonium bentonite such as CLAYTONE HT and CLAYTONE PS (both of which are available from Southern Clay). Among them, CLAYTONE AF and CLAYTONE APA are preferable.

The part of the layered inorganic mineral modified with organic anions is preferably one obtained by modifying a layered compound, DHT-4A (available from Kyowa Chemical Industry Co., Ltd.) with organic anions represented by the following General Formula (1).

R₁(OR₂)nOSO₃M General Formula (1)

[where, in General Formula (1), R₁ represents an alkyl group having 13 carbon atoms, R₂ represents an alkylene group having from 2 through 6 carbon atoms, n represents an integer of from 2 through 10, and M represents a monovalent metallic element.]

Examples of the compound represented by the General Formula (1) include HITENOL 330T (available from DKS Co. Ltd.).

### (Binder Resin)

The binder resin includes an amorphous resin, and may include a crystalline resin according to the necessity.

The amorphous resin is not particularly limited and may be appropriately selected depending on the intended purpose. For example, acrylic resins, styrene-acrylic resins, polyester resins, and epoxy resins can be selected, but polyester resins are preferable. These resins may be used in combination according to the necessity.

The amorphous polyester resin is not particularly limited and may be appropriately selected depending on the intended purpose. Examples thereof include polycondensed polyester resins synthesized from polyhydric alcohols and polycarboxylic acids.

The amorphous polyester resin is not particularly limited and may be appropriately selected depending on the intended purpose. Preferable examples thereof include amorphous polyester resins that include bivalent aliphatic alcohol components and multivalent aromatic carboxylic acid components as constituents.

Examples of the polyhydric alcohol include bivalent diols, trivalent to octavalent polyols, and nonavalent or higher polyols.

The bivalent diol is not particularly limited and may be appropriately selected depending on the intended purpose. Examples thereof include aliphatic alcohols (bivalent aliphatic alcohols) such as straight-chain aliphatic alcohols and branched aliphatic alcohols. Among them, aliphatic alcohols having from 2 through 36 chain carbon atoms are preferable, and straight-chain aliphatic alcohols having from 2 through 36 chain carbon atoms are more preferable. These may be used alone or in combination.

The straight-chain aliphatic alcohol is not particularly limited and may be appropriately selected depending on the intended purpose. Examples thereof include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-icosanediol. Among them, ethylene glycol, 1,3-propanediol (propylene glycol), 1,4-butanediol, 1,6-hexanediol, 1,9-nonanediol, and 1,10-decanediol are preferable in terms of easiness in availability. Among them, straight-chain aliphatic alcohols having from 2 through 36 chain carbon atoms are preferable.

Examples of the polycarboxylic acid include dicarboxylic acid, trivalent to hexavalent polycarboxylic acids, and heptavalent or higher polycarboxylic acids. Among them, polyvalent aromatic carboxylic acids are preferable.

The dicarboxylic acid is not particularly limited and may be appropriately selected depending on the intended purpose. Examples thereof include aliphatic dicarboxylic acids and aromatic dicarboxylic acids.

Examples of the aliphatic dicarboxylic acid include straight-chain aliphatic dicarboxylic acids and branched aliphatic dicarboxylic acids. Among them, straight-chain aliphatic dicarboxylic acids are preferable.

The aliphatic dicarboxylic acid is not particularly limited and may be appropriately selected depending on the intended purpose. Examples thereof include alkanedicarboxylic acids, alkenylsuccinic acids, alkenedicarboxylic acids, and alicyclic dicarboxylic acids.

Examples of the alkanedicarboxylic acid include alkanedicarboxylic acids having from 4 through 36 carbon atoms. Examples of the alkanedicarboxylic acid having from 4 through 36 carbon atoms include succinic acid, adipic acid, sebacic acid, azelaic acid, dodecanedicarboxylic acid, octadecanedicarboxylic acid, and decylsuccinic acid.

Examples of the alkenylsuccinic acid include dodecenylsuccinic acid, pentadecenylsuccinic acid, and octadecenylsuccinic acid.

Examples of the alkenedicarboxylic acid include alkenedicarboxylic acids having from 4 through 36 carbon atoms. Examples of the alkenedicarboxylic acid having from 4 through 36 carbon atoms include maleic acid, fumaric acid, and citraconic acid.

Examples of the alicyclic dicarboxylic acid include alicyclic dicarboxylic acids having from 6 through 40 carbon atoms. Examples of the dicarboxylic acid having from 6 through 40 carbon atoms include dimer acid (dimerized linoleic acid).

The aromatic dicarboxylic acid is not particularly limited and may be appropriately selected depending on the intended purpose. Examples of the aromatic dicarboxylic acid include aromatic dicarboxylic acids having from 8 through 36 carbon atoms. Examples of the aromatic dicarboxylic acid having from 8 through 36 carbon atoms include phthalic acid, isophthalic acid, terephthalic acid, t-butylisophthalic acid, 2,6-naphthalenedicarboxylic acid, and 4,4′-biphenyldicarboxylic acid.

Examples of the trivalent to hexavalent polycarboxylic acids and the heptavalent or higher polycarboxylic acids include aromatic polycarboxylic acids having from 9 through 20 carbon atoms. Examples of the aromatic polycarboxylic acid having from 9 through 20 carbon atoms include trimellitic acid and pyromellitic acid.

Examples of the dicarboxylic acid, the trivalent to hexavalent polycarboxylic acids, and the heptavalent or higher polycarboxylic acids include acid anhydrides of the above compounds and alkyl esters having from 1 through 4 carbon atoms. Examples of the alkyl ester having from 1 through 4 carbon atoms include methyl esters, ethyl esters, and isopropylesters.

The crystalline resin is not particularly limited and may be appropriately selected depending on the intended purpose. For example, acrylic resins, styrene-acrylic resins, polyester resins, and epoxy resins can be selected, but polyester resins are preferable.

Because the crystalline polyester has a high crystallinity, it exhibits heat melting characteristics where the viscosity decreases sharply at around a fixing starting temperature. Therefore, until just before the melting starting temperature, the crystalline polyester resin does not melt, and is excellent in a heat-resistant storage property. At the melting starting temperature, the crystalline polyester resin melts to sharply decrease the viscosity, and becomes compatible with the amorphous resin, resulting in fixing. Therefore, a toner excellent in heat-resistant storage property and low-temperature fixability can be obtained. In addition, it is possible to obtain a toner that has a large release width; i.e., a difference between the minimum fixing temperature and hot offset onset temperature.

The crystalline polyester resin is not particularly limited and may be appropriately selected depending on the intended purpose. Examples thereof include polycondensed polyester resins synthesized from polyhydric alcohols and polycarboxylic acids. Instead of polycarboxylic acids, anhydrides of polycarboxylic acids, lower alkyl esters having from 1 through 3 carbon atoms, or halides may be used.

The polyhydric alcohol is not particularly limited. Examples thereof include diols and trihydric or higher alcohols. These may be used in combination.

Examples of the diol include saturated aliphatic diols.

Examples of the saturated aliphatic diol include straight-chain saturated aliphatic diols and branched saturated aliphatic diols. Among them, straight-chain saturated aliphatic diols are preferable because a crystallinity of the crystalline polyester resin becomes high, and straight-chain saturated aliphatic diols having from 2 through 12 carbon atoms are more preferable because they are easily available.

Examples of the saturated aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-icosanediol Among them, ethylene glycol, 1,4-butanediol, 1,6-hexanediol, 1,8-octanediol, 1,10-decanediol, and 1,12-dodecanediol are preferable because of high crystallinity of the crystalline polyester resin and excellence in sharp meltability.

Examples of the trihydric or higher alcohol include glycerin, trimethylolethane, trimethylolpropane, and pentaerythritol.

The polycarboxylic acid is not particularly limited. Examples thereof include bivalent carboxylic acids and trivalent or higher carboxylic acids.

Examples of the bivalent carboxylic acid include: saturated aliphatic dicarboxylic acids such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; and aromatic dicarboxylic acids of dibasic acids such as phthalic acid, isophthalic acid, terephthalic acid, naphthalene-2,6-dicarboxylic acid, malonic acid, and mesaconic acid.

Examples of the trivalent or higher carboxylic acid include 1,2,4-benzene tricarboxylic acid, 1,2,5-benzene tricarboxylic acid, and 1,2,4-naphthalene tricarboxylic acid.

The polycarboxylic acid may include dicarboxylic acid including a sulfonic acid group.

The polycarboxylic acid may include dicarboxylic acid including a carbon-carbon double bond.

The crystalline polyester resin preferably includes a constituent unit derived from a straight-chain saturated aliphatic dicarboxylic acid having from 4 through 12 carbon atoms and a constituent unit derived from a straight-chain saturated aliphatic diol having from 2 through 12 carbon atoms. This allows the crystalline polyester resin to have high crystallinity and excellent sharp meltability. As a result, the low-temperature fixability of the toner can be improved.

The melting point of the crystalline polyester resin is preferably from 60° C. through 90° C., and more preferably from 60° C. through 80° C. When the melting point of the crystalline polyester resin is 60° C. or more, the heat-resistant storage property of the toner can be improved. When the melting point of the crystalline polyester resin is 90° C. or less, the low-temperature fixability of the toner can be improved.

The weight average molecular weight of the crystalline polyester resin is preferably from 3,000 through 30,000, and more preferably from 5,000 through 15,000. When the weight average molecular weight of the crystalline polyester resin is 3,000 or more, the heat-resistant storage property of the toner can be improved. When the weight average molecular weight of the crystalline polyester resin is 30,000 or less, the low-temperature fixability of the toner can be improved.

The acid value of the crystalline polyester resin is preferably 5 mg KOH/g or more, and more preferably 10 mg KOH/g or more. This can improve the low-temperature fixability of the toner. On the other hand, the acid value of the crystalline polyester resin is preferably 45 mg KOH/g or less. This can improve the hot offset resistance of the toner.

The hydroxyl value of the crystalline polyester resin is preferably 50 mg KOH/g or less, and more preferably from 5 mg KOH/g through 50 mg KOH/g. When the hydroxyl value of the crystalline polyester resin is 50 mg KOH/g or less, the low-temperature fixability and the charging characteristics of the toner can be improved.

The molecular structure of a crystalline polyester resin can be confirmed by, for example, solution or solid NMR spectroscopy, X-ray diffraction spectroscopy, GC/MS, LC/MS, or IR spectroscopy. Briefly, in an infrared absorption spectrum, those exhibiting absorption based on δCH (out-of-plane bending vibration) of olefin at 965±10 cm⁻¹ or 990±10 cm⁻¹ can be detected as the crystalline polyester resin.

### (Other Components)

Examples of the other components include release agents, colorants, charging controlling agents, cleanability improving agents, and magnetic materials.

### —Release Agents—

The release agent is not particularly limited. Examples thereof include vegetable waxes (e.g., carnauba wax, cotton wax, Japan wax, and rice bran wax), animal waxes (e.g., beeswax and lanolin), mineral waxes (e.g., ozokerite and selsyn), petroleum waxes (e.g., paraffin, microcrystalline, and petrolatum), hydrocarbon waxes (e.g., Fischer-Tropsch wax, polyethylene wax, and polypropylene wax), synthetic waxes (e.g., ester, ketone, and ether), and fatty acid amide compounds (e.g., 12-hydroxystearic acid amide, stearic acid amide, and anhydrous phthalic imide). Among them, paraffin waxes, microcrystalline waxes, and hydrocarbon waxes such as Fischer-Tropsch wax, polyethylene wax, and polypropylene wax are preferable.

The melting point of the release agent is preferably from 60° C. through 80° C. When the melting point of the release agent is 60° C. or more, the heat-resistant storage property of the toner can be improved. When the melting point of the release agent is 80° C. or less, the hot offset resistance of the toner can be improved.

The amount of the release agent in the toner is preferably 2% by mass or more but 10% by mass or less, and more preferably 3% by mass or more but 8% by mass or less. When the amount of the release agent in the toner is 2% by mass or more, the hot offet resistance and the low-temperature fixability of the toner can be improved. When the amount of the release agent in the toner is 10% by mass or less, the heat-resistant storage property of the toner can be improved, and generation of fogged images can be prevented.

### —Colorant—

The colorant is not particularly limited. Examples thereof include carbon black, nigrosine dyes, iron black, naphthol yellow S, Hansa yellow (10 G, 5 G, and G), cadmium yellow, yellow iron oxide, yellow ocher, yellow lead, titanium yellow, polyazo yellow, oil yellow, Hansa yellow (GR A, RN, and R), pigment yellow L, benzidine yellow (G and GR), permanent yellow (NCG), Vulcan fast yellow (5G and R), tartrazine lake, quinoline yellow lake, anthrasan yellow BGL, isoindolinon yellow, red iron oxide, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red F5R, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone. These may be used in combination.

An amount of the colorant in the toner is preferably from 1% by mass through 15% by mass, and more preferably from 3% by mass through 10% by mass.

The colorant may be composited with a resin and may be used as a master batch.

The resin is not particularly limited Examples of thereof include: amorphous polyester; polymers of styrene or substituted styrene, such as polystyrene, poly(p-chlorostyrene), and polyvinyl toluene; styrene-based copolymers, such as styrene-p-chlorostyrene copolymer, styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-methyl vinyl ketone copolymer, styrene-butadiene copolymer, styrene-isoprene copolymer, styrene-acrylonitrile-indene copolymer, styrene-maleic acid copolymer, and styrene-maleate copolymer; polymethyl methacrylate; polybutyl methacrylate; polyvinyl chloride; polyvinyl acetate; polyethylene; polypropylene; polyester; epoxy resins; epoxypolyol resins; polyurethane; polyamide; polyvinyl butyral; polyacrylic acid; rosins; modified rosins; terpene resins; aliphatic or alicyclic hydrocarbon resins; and aromatic petroleum resins. These may be used in combination.

The resin and the colorant may be mixed and kneaded to produce a master batch. At this time, an organic solvent can be used to enhance interaction between the colorant and the resin.

The master batch may be produced by a method called a flushing process, by which an aqueous paste of a colorant is mixed and kneaded with a resin and an organic solvent, and the colorant is transferred to the resin side to remove water and the organic solvent. In this case, the wet cake of the colorant can be used as it is, and thus the colorant does not need to be dried.

A mixing and kneading device is not particularly limited. Examples thereof include high shear dispersers such as three-roll mills.

### —Cleanability Improving Agent—

The cleanability improving agent is not particularly limited. Examples thereof include polymer particles produced through soap-free emulsion polymerization of for example, fatty acid metal salts such as zinc stearate and calcium stearate, polymethyl methacrylate particles, and polystyrene particles. The volume average particle diameter of the polymer particles is preferably from 0.01 μm through 1 μm.

### —Magnetic Material—

The magnetic material is not particularly limited. Examples thereof include iron, magnetite, and ferrite. Among them, white materials are preferable in terms of color tone.

### <External Additive>

The external additive is not particularly limited. Examples thereof include oxide particles (e.g., silica particles, titania particles, alumina particles, tin oxide particles, and antimony oxide particles), fatty acid metal salts (e.g., zinc stearate and aluminum stearate), and fluoropolymer particles. Among them, silica, titania, titanium oxide, and alumina that have been hydrophobized are preferable. These may be used in combination according to the necessity.

The particle diameter and the shape of the external additive can be controlled by the kind of materials of the external additive, production methods of the external additive, and hydrophobization, pulverization, and classification of the external additive.

The production method of the external additive is not particularly limited as long as the median diameters of the primary particle diameter and the secondary particle diameter can be achieved. Examples thereof include: dry methods such as a flame hydrolysis method and a flame combustion method; and wet methods such as a sol-gel method in the case of silica particles. The flame combustion method is preferable because suitable particle diameters and particle diameter distribution can be easily obtained.

In the flame combustion method, it is preferable to use a burner having a multiple pipe structure. For example, a burner having a central pipe and a circular pipe formed around the central pipe is used to mix and introduce, into the central pipe, a gasified raw material silicon compound, oxygen, and, according to the necessity, an inert gas such as nitrogen. Into the circular pipe, auxiliary flame-forming fuel such as hydrogen or hydrocarbon, and, according to the necessity, an inert gas such as nitrogen are combined and introduced. When they are burned, the silicon compound can change into silica fine particles, which can be appropriately fused in flame. According to the necessity, a burner having the second circular pipe and the third circular pipe formed around the burner can be used. The fused silica fine particles are cooled and captured in a dispersed state.

Examples of a means for controlling the primary particle diameter include: increasing the concentration of the raw material silicon compound; lengthening the length of peripheral flame; and increasing the temperature of peripheral flame. Examples of a means for controlling particle diameter distribution include adjusting the concentration of silica in flame.

A method for hydrophobizing oxide particles is not particularly limited. Examples thereof include: a method by which oxide particles are treated with a silane coupling agent; and a method by which oxide particles are treated with silicone oil.

The silane coupling agent is not particularly limited. Examples thereof include hexamethyldisilazane, methyltrimethoxysilane, methyltriethoxysilane, and octyltrimethoxysilane.

The silicone oil is not particularly limited. Examples of the silicone oil include dimethyl silicone oil, methylphenyl silicone oil, chlorophenyl silicone oil, methylhydrogen silicone oil, alkyl-modified silicone oil, fluorine-modified silicone oil, polyether-modified silicone oil, alcohol-modified silicone oil amino-modified silicone oil, epoxy-modified silicone oil, epoxy/polyether-modified silicone oil, phenol-modified silicone oil, carboxyl-modified silicone oil, mercapto-modified silicone oil, methacryl-modified silicone oil, and α-methylstyrene-modified silicone oil.

One example of the hydrophobization treatment method is, for example, a method by which a hydrophobization treatment agent is sprayed on oxide particles or a gasified hydrophobization treatment agent is mixed, followed by a heat treatment. At this time, water, amine, or other catalysts may be used. This dry surface treatment is preferably performed under an inert gas atmosphere such as nitrogen. Alternatively, a hydrophobization treatment agent is dissolved in a solvent, oxide particles are mixed and dissolved in the solvent, and, according to the necessity, the resultant is subjected to a heat treatment, followed by a dry treatment, to thereby achieve hydrophobization. The hydrophobization treatment agent may be added after or simultaneously with mixing and dispersing of silica powder in a solvent.

An amount of the external additive in the toner is preferably 0.1% by mass or more but 5% by mass or less, and more preferably 0.3% by mass or more but 3% by mass or less.

When two or more kinds of external additives are mixed, the primary particle diameters of the second and subsequent kinds of external additive particles are preferably 1 nm or more but 100 nm or less, and more preferably 3 nm or more but 70 nm or less. When the primary particle diameter of the oxide particles is 1 nm or more, the oxide particles can be prevented from being embedded in the toner base particles.

### <Toner Production Method>

A method for producing toner base particles is not particularly limited as long as the shape of toner base particles necessary to the present disclosure can be obtained. Examples thereof include the dissolution suspension method.

The toner is preferably produced by emulsifying or dispersing, in an aqueous medium, an oil phase that includes, for example, an isocyanate group-including amorphous polyester prepolymer A, an amorphous polyester resin B, and, according to the necessity, a crystalline polyester resin C, a release agent, and a colorant.

In the aqueous medium, resin particles are preferably dispersed.

The resin constituting the resin particles is not particularly limited as long as it can be dispersed in the aqueous medium. Examples thereof include vinyl resins, polyurethane, epoxy resins, polyester, polyamide, polyimide, silicon resins, phenol resins, melamine resins, urea resins, aniline resins, ionomer resins, and polycarbonate. These may be used in combination. Among them, vinyl resins, polyurethane, epoxy resins, and polyester are preferable because fine spherical resin particles can be easily obtained. A mass ratio of the resin particles to the aqueous medium is preferably from 0.005 through 0.1.

The aqueous medium is not particularly limited. Examples thereof include water and solvents that can be mixed with water. These may be used in combination. Among them, water is preferable.

The solvent that can be mixed with water is not particularly limited. Examples thereof include alcohols, dimethylformamide, tetrahydrofuran, cellosolves, and lower ketones. Examples of the alcohol include methanol, isopropanol, and ethylene glycol. Examples of the lower ketone include acetone and methyl ethyl ketone.

The oil phase can be produced by dissolving or dispersing, in an organic solvent, a toner material including, for example, an isocyanate group-including amorphous polyester prepolymer A, an amorphous polyester resin B, and, according to the necessity, a crystalline polyester resin C, a release agent, and a colorant.

A boiling point of the organic solvent is preferably less than 150° C. This can easily remove the organic solvent.

The organic solvent is not particularly limited. Examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These may be used in combination. Among them, ethyl acetate, toluene, xylene, benzene, methylene chloride, 1,2-dichloroethane, chloroform, and carbon tetrachloride are preferable, and ethyl acetate is more preferable.

When the oil phase is emulsified or dispersed in the aqueous medium, the isocyanate group-including amorphous polyester prepolymer A and an active hydrogen group-including compound are allowed to react to form an amorphous polyester resin A.

The amorphous polyester resin A can be produced in the following methods (1) to (3).

(1) a method by which an oil phase including an isocyanate group-including amorphous polyester prepolymer A and an active hydrogen group-including compound is emulsified or dispersed in an aqueous medium, and the active hydrogen group-including compound and the isocyanate group-including amorphous polyester prepolymer A are extended and/or cross-linked in the aqueous medium, to form an amorphous polyester resin A.

(2) a method by which an oil phase that includes an isocyanate group-including amorphous polyester prepolymer A is emulsified or dispersed in an aqueous medium to which an active hydrogen group-including compound has been added in advance, and the active hydrogen group-including compound and the isocyanate group-including amorphous polyester prepolymer A are extended and/or cross-linked in an aqueous medium, to form an amorphous polyester resin A.

(3) a method by which after an oil phase that includes an isocyanate group-including amorphous polyester prepolymer A is emulsified or dispersed in an aqueous medium, an active hydrogen group-including compound is added to the aqueous medium, and the active hydrogen group-including compound and the isocyanate group-including amorphous polyester prepolymer A are extended or cross-linked from the boundaries of particles in the aqueous medium, to form an amorphous polyester resin A.

When the active hydrogen group-including compound and the isocyanate group-including amorphous polyester prepolymer A are extended or cross-linked from the boundaries of particles, the amorphous polyester resin A is preferentially formed on the surface of the produced toner, and the concentration gradient of the amorphous polyester resin A can be formed in the toner.

Time to react the active hydrogen group-including compound with the isocyanate group-including amorphous polyester prepolymer A is preferably from 10 minutes through 40 hours, and more preferably from 2 hours through 24 hours.

A temperature at which the active hydrogen group-including compound and the isocyanate group-including amorphous polyester prepolymer A are allowed to react is preferably from 0° C. through 150° C., and more preferably from 40° C. through 98° C.

When the active hydrogen group-including compound and the isocyanate group-including amorphous polyester prepolymer A are allowed to react, a catalyst can be used.

The catalyst is not particularly limited. Examples thereof include dibutyltin laurate and dioctyltin laurate.

A method for emulsifying or dispersing the oil phase in the aqueous medium is not particularly limited. Examples thereof include a method by which the oil phase is added to the aqueous medium and is dispersed by a shear force.

A disperser used for emulsifying or dispersing the oil phase in the aqueous medium is not particularly limited. Examples thereof include low-speed shearing dispersers, high-speed shearing dispersers, friction dispersers, high-pressure jet dispersers, and ultrasonic wave dispersers. Among them, high-speed shearing dispersers are preferable because the particle diameter of a dispersing element (oil droplets) can be adjusted to from 2 μm through 20 μm.

When the high-speed shearing disperser is used, the number of revolutions is preferably from 1,000 rpm through 30,000 rpm, and more preferably from 5,000 rpm through 20,000 rpm. The dispersion time is preferably from 0.1 minutes through 5 minutes in the case of the batch method. The dispersion temperature is preferably from 0° C. through 150° C., and more preferably from 40° C. through 98° C. under pressure.

A mass ratio of the aqueous medium to the toner materials is preferably from 0.5 through 20, and more preferably from 1 through 10. When the mass ratio of the aqueous medium to the toner materials is 0.5 or more, the oil phase can be favorably dispersed. The mass ratio of 20 or less is cost-effective.

The aqueous medium preferably includes a dispersing agent. This makes it possible to improve the dispersion stability of oil droplets when the oil phase is emulsified or dispersed in the aqueous medium, the toner base particles may have a desired shape, and the particle size distribution can be narrow.

The dispersing agent is not particularly limited. Examples thereof include surfactants, poorly water-soluble inorganic compound dispersing agents, and high-molecular protective colloids. These may be used in combination. Among them, surfactants are preferable.

Examples of the surfactant include anionic surfactants, cationic surfactants, nonionic surfactants, and amphoteric surfactants. Among them, fluoroalkyl group-including surfactants are preferable.

Examples of the anionic surfactant include alkyl benzene sulfonate, α-olefin sulfonate, and phosphate.

Preferably, the aqueous medium further includes a coagulant. This makes it possible for toner base particles to have such a shape as large and wide concavities, and to meet the requirements of the shape of the toner base particles necessary for the present disclosure.

The coagulant is not particularly limited. Examples thereof include inorganic metal salts and bivalent or higher metal complexes. These may be used in combination. Among them, inorganic metal salts are preferable.

Examples of the inorganic metal salt include sodium salts, magnesium salts, aluminum salts, and polymers thereof. In terms of the particle diameter of the toner and easiness in shape control, sodium salts are preferable. Examples of the sodium salt include sodium chloride and sodium sulfate.

An amount of the coagulant in the aqueous medium can be appropriately changed. The amount is preferably from 1.2% by mass through 5.0% by mass, and more preferably from 1.2% by mass through 3.0% by mass based on a solid content.

After the oil phase is dispersed in the aqueous medium, the organic solvent is preferably removed to form toner base particles.

A method for removing the organic solvent is not particularly limited. Examples of the method include: a method by which an aqueous medium in which an oil phase is dispersed is gradually heated, to vaporize an organic solvent in oil droplets; and a method by which an aqueous medium in which an oil phase is dispersed is sprayed in a dry atmosphere, to remove an organic solvent in oil droplets.

After toner base particles are washed, they are preferably dried. At this time, the toner base particles may be classified. Specifically, using a cyclone, a decanter, a centrifugal machine or the like, fine particles may be removed from toner base particles included in an aqueous medium to classify the toner base particles, or dried toner base particles may be classified.

A toner is produced by mixing toner base particles with an external additive and, according to the necessity, a charging controlling agent. At this time, application of mechanical impact to the mixture makes it possible to prevent the external additive from being detached from the surfaces of the toner base particles.

A method for applying mechanical impact to a mixture is not particularly limited. Examples thereof include: a method by which impact is applied to a mixture by rotating a blade at a high speed; and a method by which a mixture is charged into an air flow that moves at a high speed, and particles are allowed to collide with each other or with an impact plate.

Examples of a commercially available device for applying mechanical impact to a mixture include: ANGMILL (available from HOSOKAWA MICRON CORPORATION), a device obtained by modifying a model-I mill (Nippon Pneumatic Mfg. Co., Ltd.) to decrease the pulverization air pressure, HYBRIDIZATION SYSTEM (available from Nara Machinery Co., Ltd.), and KRYPTRON SYSTEM (available from Kawasaki Heavy Industries, Ltd.).

### (Developer)

The developer of the present disclosure includes at least the toner, and may further include appropriately selected other components, such as a carrier, according to the necessity.

Therefore, the developer can achieve excellent charging ability and transferability, and can stably form an image with high quality. The developer may be a one-component developer or two-component developer. When the developer is used for a high-speed printer that responds to recent improvement in an information processing speed, a two-component developer is preferably used because service life can be improved.

When the developer is used as a one-component developer, there is a slight change in the particle diameter of the toner even after the toner is consumed and refilled, filming of the toner to a developing roller and fusion of the toner to a member such as a blade for thinning a layer of the toner are hardly caused, and excellent and stable developing properties and images are obtained even after the developer is stirred in a developing device for a long period of time.

When the developer is used as a two-component developer, there is a slight change in the particle diameter of the toner after the toner is consumed and refilled for a long period of time, and excellent and stable developing properties and images are obtained even after the developer is stirred in a developing device for a long period of time.

### <Carrier>

The carrier is not particularly limited, and may be appropriately selected depending on the intended purpose. The carrier preferably includes a core and a resin layer covering the core.

### —Core—

A material of the core is not particularly limited, and may be appropriately selected depending on the intended purpose. Examples thereof include manganese-strontium-based materials of from 50 emu/g through 90 emu/g, and manganese-magnesium-based materials of from 50 emu/g through 90 emu/g. In order to ensure image density, a high magnetic material, such as iron powder of 100 emu/g or greater and magnetite of from 75 emu/g through 120 emu/g is preferably used. Moreover, low magnetic materials, such as copper/zinc-based materials of from 30 emu/g through 80 emu/g are preferably used because impact of the developer in the form of a brush to the photoconductor can be weakened, and an image with high quality can be advantageously formed.

These may be used alone or in combination.

A volume average particle diameter of the core is not particularly limited and may be appropriately selected depending on the intended purpose. The volume average particle diameter is preferably from 10 μm through 150 μm, and more preferably from 40 μm through 100 μm.

When the volume average particle diameter is 10 μm or more, it is possible to overcome such problems that a lot of fine powder forms in a carrier, and magnetization per particle decreases to scatter the carrier.

When the volume average particle diameter is 150 μm or less, it is possible to overcome such problems that the specific surface area may decrease to scatter the toner, and particularly reproduction of solid portions may be worsen in a full color image having a lot of solid portions.

When the toner is used for a two-component developer, the toner may be mixed with the carrier for use. An amount of the carrier in the two-component developer is not particularly limited, and may be appropriately selected depending on the intended purpose. The amount of the carrier is preferably from 90 parts by mass through 98 parts by mass, and more preferably from 93 parts by mass through 97 parts by mass, relative to 100 parts by mass of the two-component developer.

The developer of the present disclosure is suitably used for image formation according to various electrophotographic methods known in the art, such as a magnetic one-component developing method, a non-magnetic one-component developing method, and a two-component developing method.

In the present disclosure, the toner storage unit includes a unit configured to store a toner and a toner stored in the unit. Examples of an embodiment of the toner storage unit include toner storage containers, developing devices, and process cartridges.

The toner storage container includes a container, and a toner stored in the container.

The developing device is a developing unit that stores a toner, and is configured to develop the toner.

The process cartridge includes at least an image bearer and a developing unit as an integrated body, stores a toner therein, and can be detachably mounted in an image forming apparatus. The process cartridge may further include at least one selected from the group consisting of a charging unit, an exposing unit, and a cleaning unit.

When the toner storage unit of the present disclosure is mounted on the image forming apparatus to form an image, cleanability and high transfer efficiency can be maintained, which means that the image formation that makes the most of the features of the toner of the present disclosure can be performed.

Hereinafter, a developer storage container that particularly stores a developer containing a toner will be described.

### (Developer Storage Container)

The developer storage container according to the present disclosure stores the developer of the present disclosure, and its container is not particularly limited and may be appropriately selected from those known in the art. Examples of the container include a container that includes a container main body and a cap.

The size, shape, structure, and material of the developer storage container main body are not particularly limited. Preferably, the developer storage container main body has, for example, a cylindrical shape. Particularly preferably, the developer storage container main body includes spiral unevenness on the inner peripheral surface and can be rotated to transfer the contents, the developer to the discharge port side, and part or all of the spiral unevenness includes a bellows property.

The material of the developer storage container is not particularly limited, but such a material that has a good dimensional accuracy is preferable. Examples thereof include resin materials such as polyester resins, polyethylene resins polypropylene resins, polystyrene resins, polyvinyl chloride resins, polyacrylic acid, polycarbonate resins. ABS resins, and polyacetal resins.

The developer storage container is easily stored or transported and shows an excellent handling property. Therefore, the developer storage container is detachably mounted on, for example, a process cartridge and an image forming apparatus, and can be used for supplementing the developer.

### (Image Forming Apparatus and Image Forming Method)

The image forming apparatus of the present disclosure includes at least an electrostatic latent image bearer, an electrostatic latent image forming unit, and a developing unit. The image forming apparatus may further include other units according to the necessity.

The image forming method according to the present disclosure includes a charging step, an exposing step, a developing step, a primary transferring step, a secondary transferring step, a fixing step, and a cleaning step, and further includes other steps according to the necessity.

The image forming method can be suitably performed by the image forming apparatus. The charging step and the exposing step can be suitably performed by the electrostatic latent image forming step. The developing step can be suitably performed by the developing unit. The other steps can be suitably performed by the other units.

### <Electrostatic Latent Image Bearer>

A material, structure, and size of the electrostatic latent image bearer are not particularly limited, and may be appropriately selected from materials, structures, and sizes thereof known in the art. Examples of the materials include inorganic photoconductors (e.g., amorphous silicon and selenium) and organic photoconductors (e.g., polysilane and phthalopolymethine). Among them, amorphous silicon is preferable in terms of long service life.

As the amorphous silicon photoconductor, for example, it is possible to use a photoconductor including a photoconductor layer formed of a-Si, which is obtained by heating a support to a temperature of from 50° C. through 400° C., and forming a film of a-Si on the support by a film formation method, such as vacuum vapor deposition, sputtering, ion plating, thermal chemical vapor deposition (CVD), photo CVD, or plasma CVD. Among them, it is preferable to form an a-Si deposition film by a plasma CVD method, by which a raw material gas is decomposed by direct current, high frequency waves, or microwave glow discharge, to form an a-Si deposition film on a support.

A shape of the electrostatic latent image bearer is not particularly limited, and may be appropriately selected depending on the intended purpose. The electrostatic latent image bearer preferably has a cylindrical shape. The outer diameter of the cylindrical electrostatic latent image bearer is not particularly limited, and may be appropriately selected depending on the intended purpose. The outer diameter thereof is preferably from 3 mm through 100 mm, more preferably from 5 mm through 50 mm, and particularly preferably from 10 mm through 30 mm.

### <Electrostatic Latent Image Forming Unit and Electrostatic Latent Image Forming Step>

The electrostatic latent image forming unit is not particularly limited, and may be appropriately selected depending on the intended purpose, as long as the electrostatic latent image forming unit is a unit configured to form an electrostatic latent image on the electrostatic latent image bearer. Examples thereof include a unit including a charging member configured to charge a surface of the electrostatic latent image bearer, and an exposing member configured to expose the surface of the electrostatic latent image bearer to light imagewise.

The electrostatic latent image forming step is not particularly limited, and may be appropriately selected depending on the intended purpose, as long as the electrostatic latent image forming step is a step of forming an electrostatic latent image on the electrostatic latent image bearer. For example, the electrostatic latent image forming step can be performed by charging the surface of the electrostatic latent image bearer, followed by exposing the surface of the electrostatic latent image bearer to light imagewise. The electrostatic latent image forming step can be performed by the electrostatic latent image forming unit.

### —Charging Member and Charging—

The charging member is not particularly limited, and may be appropriately selected depending on the intended purpose. Examples of the charging member include: contact chargers known in the art, equipped with, for example, a conductive or semiconductive roller, brush, film, or rubber blade; and non-contact chargers utilizing corona discharge, such as corotron and scorotron.

For example, the charging can be performed by applying voltage to the surface of the electrostatic latent image bearer using the charging member.

As a shape of the charging member, the charging member may be in any shape, such as a magnetic brush, and a fur brush, as well as a roller. The shape of the charging member may be selected depending on the specification or embodiment of the image forming apparatus.

The charging member is not limited to the above-mentioned contact charging member, but a contact charging member is preferably used because an image forming apparatus including such a charging member can reduce an amount of ozone generated from the charging member.

### —Exposing Unit and Exposing—

The exposing unit is not particularly limited, and may be appropriately selected depending on the intended purpose, as long as the exposing unit can expose the surface of the electrostatic latent image bearer charged by the charging member to light, so that the shape of an image to be formed can be achieved. Examples thereof include various exposing units, such as a copy optical exposing unit, a rod lens array exposing unit, a laser optical exposing unit, and a liquid crystal shutter optical exposing unit.

A light source used for the exposing unit is not particularly limited, and may be appropriately selected depending on the intended purpose. Examples thereof include general light emitters, such as fluorescent lamps, tungsten lamps, halogen lamps, mercury lamps, sodium vapor lamps, light emitting diodes (LED), semiconductor lasers (LDs), and electroluminescent light (EL).

In order to emit only light having a desired wavelength range, various filters, such as sharp-cut filters, band-pass filters, near infrared ray-cut filters, dichroic filters, interference filters, and color temperature conversion filters, may be used.

For example, the exposing may be performed by exposing the surface of the electrostatic latent image bearer to light imagewise using the exposing unit.

In the present disclosure, a back-exposure system may be employed. The back-exposure system is a system where imagewise light exposure is performed from the back side of the electrostatic latent image bearer.

### <Developing Unit and Developing Step>

The developing unit is not particularly limited, and may be appropriately selected depending on the intended purpose, as long as the developing unit stores a toner, and is configured to develop the electrostatic latent image formed on the electrostatic latent image bearer with the toner to form a visible image.

The developing step is not particularly limited, and may be appropriately selected depending on the intended purpose, as long as the developing step is a step of developing the electrostatic latent image formed on the electrostatic latent image bearer with a toner to form a visible image. For example, the developing step may be performed by the developing unit.

The developing unit may employ a dry developing system or a wet developing system. Moreover, the developing unit may be a developing unit for a single color, or a developing unit for multiple colors.

Preferably, the developing unit is a developing device including a stirrer configured to stir the toner to charge the toner with friction and a rotatable developer bearer that includes a magnetic field generating unit fixed inside of the developer bearer, and is configured to bear a developer including the toner on a surface thereof.

Inside the developing unit, for example, the toner and the carrier are mixed and stirred to charge the toner with friction, and the charged toner is held on the surface of the rotating magnetic roller in the form of a brush to form a magnetic brush. The magnetic roller is disposed near the electrostatic latent image bearer. Therefore, part of the toner constituting the magnetic brush formed on the surface of the magnetic roller moves onto the surface of the electrostatic latent image bearer by an electric suction force. As a result, the electrostatic latent image is developed with the toner to form a visible image with the toner on the surface of the electrostatic latent image bearer.

### <Other Units and Other Steps>

Examples of the other units include transferring units, fixing units, cleaning units, charge-eliminating units, recycling units, and controlling units.

Examples of the other steps include a transferring step, a fixing step, a cleaning step, a charge-eliminating step, a recycling step, and a controlling step.

### —Transferring Unit and Transferring Step—

The transferring unit is not particularly limited, and may be appropriately selected depending on the intended purpose, as long as the transferring unit is a unit configured to transfer the visible image to a recording medium. An embodiment including a first transferring unit and a second transferring unit is preferable, where the first transferring unit is configured to transfer the visible image to an intermediate transfer member to form a composite transfer image, and the second transferring unit is configured to transfer the composite transfer image to a recording medium.

The transferring step is not particularly limited, and may be appropriately selected depending on the intended purpose, as long as the transferring step is a step of transferring the visible image to a recording medium. It is preferable to use an embodiment that includes primarily transferring visible images to an intermediate transfer member, followed by secondarily transferring the visible images to the recording medium.

For example, the transferring step can be performed by charging the photoconductor with a transfer charger, and the transferring step can be performed by the transferring unit.

When an image secondarily transferred to the recording medium is a color image composed of multiple color toners, toners of several colors can be sequentially superimposed on the intermediate transfer member by the transferring unit to form an image on the intermediate transfer member, and the image on the intermediate transfer member can be secondarily transferred to the recording medium by the intermediate transfer member at one time.

The intermediate transfer member is not particularly limited and may be appropriately selected from known transfer members according to the intended purpose. For example, a transfer belt is preferably used.

The transferring unit (e.g., the primary transferring unit, and the secondary transferring unit) preferably includes at least a transfer device configured to allow the visible image formed on the photoconductor to experience peeling electrification to the side of the recording medium. Examples of the transfer device include corona transfer devices using corona discharge, transfer belts, transfer rollers, press transfer rollers, and adhesion transfer devices.

The recording medium is typically plane paper. The recording medium is not particularly limited and may be appropriately selected depending on the intended purpose, as long as the recording medium is a medium to which an unfixed image after developing can be transferred. A PET base for OHP may be also used.

### —Fixing Unit and Fixing Step—

The fixing unit is not particularly limited, and may be appropriately selected depending on the intended purpose, as long as the fixing unit is a unit configured to fix the transfer image transferred to the recording medium. The fixing unit is preferably a known heat press member. Examples of the heat press member include a combination of a heating roller and a press roller, and a combination of a heat roller, a press roller, and an endless belt.

The fixing step is not particularly limited, and may be appropriately selected depending on the intended purpose, as long as the fixing step is a step of fixing the visible image transferred to the recording medium. For example, the fixing step may be performed every time the toner of each color is transferred to the recording medium, or the fixing step may be performed at one time with the toners of all colors being superimposed.

The fixing step can be performed by the fixing unit.

Preferably, heating by the press heat member is typically performed at from 80° C. through 200° C.

In the present disclosure, for example, a known optical fixing device may be used in combination with or instead of the fixing unit according to the intended purpose.

The surface pressure applied during the fixing step is not particularly limited, and may be appropriately selected depending on the intended purpose. The surface pressure is preferably from 10 N/cm² through 80 N/cm².

### —Cleaning Unit and Cleaning Step—

The cleaning unit is not particularly limited, and may be appropriately selected depending on the intended purpose, as long as the cleaning unit is a unit capable of removing the toner remaining on the photoconductor. Examples of the cleaning unit include magnetic brush cleaners, electrostatic brush cleaners, magnetic roller cleaners, blade cleaners, brush cleaners, and web cleaners.

The cleaning step is not particularly limited, and may be appropriately selected depending on the intended purpose, as long as the cleaning step is a step of removing the toner remaining on the photoconductor. For example, the cleaning step can be performed by the cleaning unit.

### —Charge-Eliminating Unit and Charge-Eliminating Step—

The charge-eliminating unit is not particularly limited, and may be appropriately selected depending on the intended purpose, as long as the charge-eliminating unit is a unit configured to apply charge-eliminating bias to the photoconductor to eliminate the charge of the photoconductor. Examples of the charge-eliminating unit include charge-eliminating lamps.

The charge-eliminating step is not particularly limited, and may be appropriately selected depending on the intended purpose, as long as the charge-eliminating step is a step of applying charge-eliminating bias to the photoconductor to eliminate the charge of the photoconductor. For example, the charge-eliminating step can be performed by the charge-eliminating unit.

### —Recycling Unit and Recycling Step—

The recycling unit is not particularly limited, and may be appropriately selected depending on the intended purpose, as long as the recycling unit is a unit configured to recycle the toner removed by the cleaning step to the developing device. Examples of the recycling unit include known conveying units.

The recycling step is not particularly limited, and may be appropriately selected depending on the intended purpose, as long as the recycling step is a step of recycling the toner removed by the cleaning step to the developing device. For example, the recycling step can be performed by the recycling unit.

### —Controlling Unit and Controlling Step—

The controlling unit is not particularly limited, and may be appropriately selected depending on the intended purpose, as long as the controlling unit is a unit configured to control the operation of each of the above-mentioned units. Examples of the controlling unit include sequencers and computers.

The controlling step is not particularly limited, and may be appropriately selected depending on the intended purpose, as long as the controlling step is a step of controlling the operation of each of the above-mentioned steps. For example, the controlling step can be performed by the controlling unit.

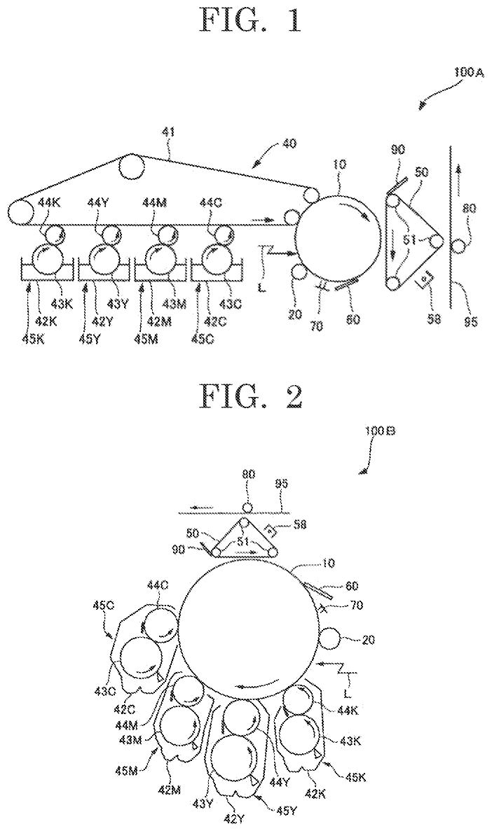

Next, one embodiment of a method for forming an image using the image forming apparatus of the present disclosure will be described with reference to FIG. 1. A color image forming apparatus 100A illustrated in FIG. 1 includes a photoconductor drum 10 (may be referred to as a “photoconductor 10” hereinafter) serving as the electrostatic latent image bearer, a charging roller 20 serving as the charging unit, an exposing device serving as the exposing unit, a developing device 40 serving as the developing unit, an intermediate transfer member 50, a cleaning device 60 serving as the cleaning unit including a cleaning blade, and a charge-eliminating lamp 70 serving as the charge-eliminating unit.

The intermediate transfer member 50 is an endless belt supported by three rollers 51 disposed inside the intermediate transfer member 50, and can move in the direction indicated with the arrow. Part of the three rollers 51 also functions as a transfer bias roller capable of applying a predetermined transfer bias (i.e., primary transfer bias) to the intermediate transfer member 50. The cleaning device 90 including the cleaning blade is disposed near the intermediate transfer member 50. Moreover, the transfer roller 80 is disposed near the intermediate transfer member 50 so as to face the intermediate transfer member 50, and the transfer roller 80 is capable of applying transfer bias for transferring (secondarily transferring) the developed image (toner image) to transfer paper 95 serving as a recording medium. At the periphery of the intermediate transfer member 50, a corona charger 58 configured to apply charge to the toner image on the intermediate transfer member 50 is disposed between a contact area of the photoconductor 10 and the intermediate transfer member 50 and a contact area of the intermediate transfer member 50 and the transfer paper 95 in the rotational direction of the intermediate transfer member 50.

The developing device 40 includes a developing belt 41 serving as the developer bearer, and a black developing unit 45K, a yellow developing unit 45Y, a magenta developing unit 45M, and a cyan developing unit 45C disposed together at the periphery of the developing belt 41. The black developing unit 45K includes a developer storage unit 42K, a developer supply roller 43K, and a developing roller 44K The yellow developing unit 45Y includes a developer storage unit 42Y, a developer supply roller 43Y, and a developing roller 44Y. The magenta developing unit 45M includes a developer storage unit 42M, a developer supply roller 43M, and a developing roller 44M. The cyan developing unit 45C includes a developer storage unit 42C, a developer supply roller 43C, and a developing roller 44C. Moreover, the developing belt 41 is an endless belt rotatably supported by a plurality of belt rollers, and part of the developing belt 41 is in contact with the electrostatic latent image bearer 10.

In the color image forming apparatus 100A illustrated in FIG. 1, for example, the charging roller 20 uniformly charges the photoconductor drum 10. The photoconductor drum 10 is exposed to light imagewise by exposure light L emitted from the exposing device to form an electrostatic latent image. The electrostatic latent image formed on the photoconductor drum 10 is developed with the toner supplied from the developing device 40 to form a toner image. The toner image is transferred (primarily transferred) to the intermediate transfer member 50 by voltage applied from the roller 51, and is then transferred (secondarily transferred) to transfer paper 95. As a result, a transferred image is formed on the transfer paper 95. The toner remaining on the photoconductor 10 is removed by the cleaning device 60, and the charging of the photoconductor 10 is eliminated by the charge-eliminating lamp 70.

FIG. 2 illustrates another example of the image forming apparatus of the present disclosure. The image forming apparatus 100B has the structure identical to the structure of the image forming apparatus 100A illustrated in FIG. 1, except that the developing belt 41 is not disposed, and the black developing unit 45K, the yellow developing unit 45Y, the magenta developing unit 45M, and the cyan developing unit 45C are disposed at the periphery of the photoconductor drum 10 so as to directly face the photoconductor drum 10.

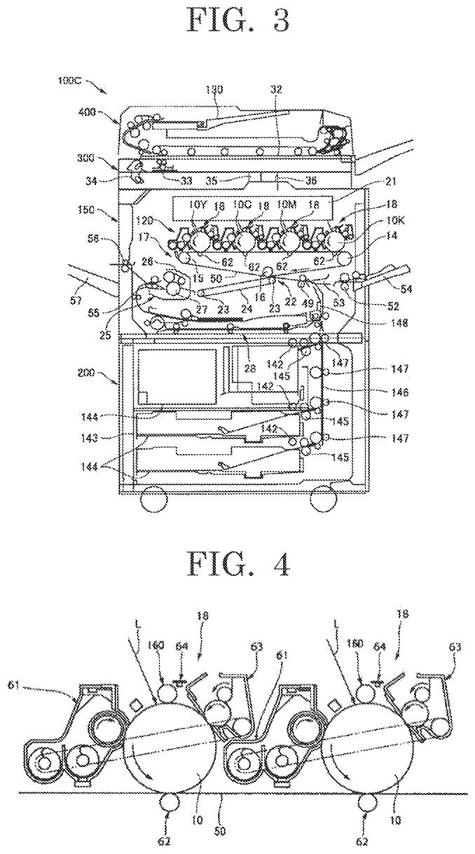

FIG. 3 illustrates another example of the image forming apparatus of the present disclosure. The image forming apparatus 1000 illustrated in FIG. 3 includes a photocopier main body 150, a paper feeding table 200, a scanner 300, and an automatic document feeder (ADF) 400.

At the center of the photocopier main body 150, an endless belt type intermediate transfer member 50 is disposed. The intermediate transfer member 50 is supported by supporting rollers 14, 15, and 16, and can rotate in the clockwise direction in FIG. 3. An intermediate transfer member cleaning device 17 configured to remove the toner remaining on the intermediate transfer member 50 is disposed near the supporting roller 15. A tandem developing device 120, in which four image forming units 18 of yellow, cyan, magenta, and black are arranged side by side so as to face the intermediate transfer member 50 in its conveying direction, is disposed near the intermediate transfer member 50 supported by the supporting roller 14 and the supporting roller 15. An exposing device 21, which is the exposing unit, is disposed near the tandem developing device 120. A secondary transferring device 22 is disposed at the opposite side of the intermediate transfer member 50 to the side where the tandem developing device 120 is disposed. In the secondary transferring device 22, a secondary transfer belt 24, which is an endless belt, is supported by a pair of rollers 23, and transfer paper conveyed on the secondary transfer belt 24 comes in contact with the intermediate transfer member 50. A fixing device 25, which is the fixing unit, is disposed near the secondary transferring device 22. The fixing device 25 includes a fixing belt 26, which is an endless belt, and a press roller 27 disposed so as to be pressed by the fixing belt 26.

In the tandem image forming apparatus, a sheet reverser 28, which is configured to reverse the transfer sheet in order to form images on the both sides of the transfer paper, is disposed near the secondary transferring device 22 and the fixing device 25.

Next, formation of a full-color image (color copy) using the tandem developing device 120 will be described. First, a document is set on a document table 130 of the automatic document feeder (ADF) 400. Alternatively, the automatic document feeder is open, a document is set on a contact glass 32 of a scanner 300, and the automatic document feeder 400 is closed.

In the case where a start switch (not illustrated) is pressed, when the document is set on the automatic document feeder 400, a scanner 300 is driven after the document is transported and moved to the contact glass 32. When the document is set on the contact glass 32, the scanner 300 is immediately driven. Then, a first carriage 33 and a second carriage 34 run. Light emitted from a light source is emitted by the first carriage 33, and the light reflected from the surface of the document is reflected by the mirror of the second carriage 34, and the reflected light is received by a reading sensor 36 via an imaging forming lens 35 to read the color document (color image). Then, image information of black, yellow, magenta, and cyan can be obtained.

Each image formation of black, yellow, magenta, and cyan is transmitted to each image forming unit 18 (the black image forming unit, the yellow image forming unit, the magenta image forming unit, and the cyan image forming unit) of the tandem developing device 120. In each image forming unit, each of the toner images of black, yellow, magenta, and cyan is formed.

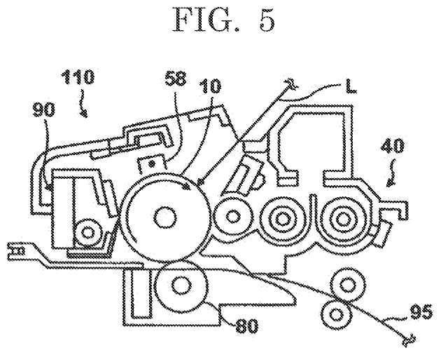

As illustrated in FIG. 4, specifically, each image forming unit 18 (the black image forming unit, the yellow image forming unit, the magenta image forming unit, or the cyan image forming unit) in the tandem developing device 120 includes: an electrostatic latent image bearer 10 (a black electrostatic latent image bearer 10K, a yellow electrostatic latent image bearer 10Y, a magenta electrostatic latent image bearer 10M, or a cyan electrostatic latent image bearer 10C); a charging device 160, which is the charging unit, configured to uniformly charge the electrostatic latent image bearer 10; an exposing device configured to imagewise expose the electrostatic latent image bearer to light (L in FIG. 4) so as to form an image corresponding to each color image based on each color image information to form an electrostatic latent image corresponding to each color image on the electrostatic latent image bearer a developing device 61, which is the developing unit, configured to develop the electrostatic latent image with each color toner (a black toner, a yellow toner, a magenta toner, or a cyan toner) to form a toner image formed of each color toner; a transfer charger 62 configured to transfer the toner image to an intermediate transfer member 50; a cleaning device 63; and a charge-eliminating unit 64. Each image forming unit 18 can form an image of each color (a black image, a yellow image, a magenta image, or a cyan image) based on each color image information. The black image, the yellow image, the magenta image, and the cyan image formed in the above-described manner, namely, the black image formed on the black electrostatic latent image bearer 10K the yellow image formed on the yellow electrostatic latent image bearer 10Y, the magenta image formed on the magenta electrostatic latent image bearer 10M, and the cyan image formed on the cyan electrostatic latent image bearer 10C are sequentially transferred (primarily transferred) to the intermediate transfer member 50 that is rotatably moved by the supporting rollers 14, 15, and 16. The black image, the yellow image, the magenta image, and the cyan image are superimposed on the intermediate transfer member 50 to form a composite color image (a color transferred image).

One of the paper feeding rollers 142 is selectively rotated in the paper feeding table 200 to eject sheets (recording paper) from one of multiple paper feeding cassettes 144 of a paper bank 143. The sheets are separated one by one by a separation roller 145 to send each sheet to a paper feeding path 146, and then transported by a conveying roller 147. Then, the sheet is guided into a paper feeding path 148 within the photocopier main body 150. The sheet transported in the paper feeding path 148 is then bumped against a registration roller 49 to stop. Alternatively, sheets (recording paper) on a sheet feeding tray 54 are ejected by rotating the paper feeding roller 142, and the ejected sheets are separated one by one by the separation roller 52. Then, the sheets are sent to a manual paper feeding path 53, and is bumped against the registration roller 49 to stop. The registration roller 49 is generally earthed for use, but may be used with bias being applied thereto in order to remove paper dusts of the sheets. The registration roller 49 is rotated synchronously with the timing of the composite color image (color transferred image) formed on the intermediate transfer member 50 to send the sheet (the recording paper) between the intermediate transfer member 50 and the secondary transferring device 22. This makes it possible to transfer and form the color image on the sheet (recording paper). The toner remaining on the intermediate transfer member 50 after transferring the image is cleaned by the intermediate transfer member cleaning device 17.

The sheet (the recording paper) to which the color image has been transferred is transported by the secondary transferring device 22 to be sent to the fixing device 25. In the fixing device 25, the composite color image (the color transferred image) is fixed on the sheet (the recording paper) by heat and pressure. Thereafter, the sheet (the recording paper) is switched by a separation craw 55, and is ejected by an ejecting roller 56. Then, the sheet (the recording paper) is stacked on a paper ejection tray 57. Alternatively, the sheet is switched by the separation craw 55, and is reversed by the sheet reverser 28. Then, the sheet is guided again to the transfer position to record an image on the back side of the sheet. Thereafter, the sheet is ejected by the ejecting roller 56 and is stacked on the paper ejection tray 57.

### (Process Cartridge)

The process cartridge according to the present disclosure can be detachably mounted on various image forming apparatuses. The process cartridge includes an electrostatic latent image bearer configured to bear an electrostatic latent image, and a developing unit configured to develop the electrostatic latent image born on the electrostatic latent image bearer with the toner of the present disclosure to form a toner image. The process cartridge of the present disclosure may further include other units according to the necessity.

The developing unit includes at least a developer storage container storing the developer of the present disclosure, and a developer bearing member configured to bear the developer stored inside the developer storage container and transport the developer. The developing unit may further include a regulating member configured to regulate a thickness of the born developer.

FIG. 5 illustrates an example of the process cartridge according to the present disclosure. A process cartridge 110 includes a photoconductor drum 10, a corona discharger 58, a developing device 40, a transfer roller 80, and a cleaning device 90. Note that, the sign 95 represents transfer paper and the sign L represents exposure light.

### EXAMPLES

The present disclosure will be described in details by way of Examples. However, the present disclosure should not be limited to the following Examples. Hereinafter, “part(s)” means part(s) by mass and “%” means % by mass unless otherwise specified.

### (Synthesis of Ketamine 1)

A reaction vessel equipped with a stirring rod and a thermometer was charged with 170 parts of isophoronediamine and 75 parts of methyl ethyl ketone, and the resultant mixture was allowed to react at 50° C. for 5 hours to thereby obtain [Ketimine 1]. The [Ketimine 1] had an amine value of 418 mg KOH/g.

### (Synthesis of Amorphous Polyester Prepolymer A)

A reaction vessel equipped with a cooling tube, a stirrer, and a nitrogen-introducing tube was charged with 3-methyl-1,5-pentanediol, adipic acid, and trimellitic anhydride. At this time, the molar ratio of the hydroxyl group to the carboxyl group was 1.5, the amount of trimellitic anhydride in the total amount of monomers was 1 mol %, and 1,000 ppm of titanium tetraisopropoxide was added to the total amount of monomers. Then, the resultant was heated to 200° C. for about 4 hours, and was further heated to 230° C. for 2 hours. After the resultant was allowed to react until water was not discharged, it was allowed to react for 5 hours under reduced pressure of from 10 mm Hg through 15 mm Hg, to obtain [hydroxyl group-containing amorphous polyester].

A reaction vessel equipped with a cooling tube, a stirrer, and a nitrogen-introducing tube was charged with the [hydroxyl group-containing amorphous polyester] and isophorone diisocyanate. At this time, the molar ratio of the isocyanate group to the hydroxyl group was 2.0. After diluted with ethyl acetate, the resultant was allowed to react at 100° C. for 5 hours, to obtain a 50% ethyl acetate solution of the [amorphous polyester prepolymer A].

### (Synthesis of Amorphous Polyester Resin B)

A reaction vessel equipped with a nitrogen-introducing tube, a dewatering tube, a stirrer, and a thermocouple was charged with bisphenol A ethylene oxide (2 mol) adduct (referred to as BisA-EO), bisphenol A propylene oxide (3 mol) adduct (referred to as BisA-PO), terephthalic acid, and adipic acid. At this time, the molar ratio of BisA-EO to BisA-PO was 40/60, the molar ratio of terephthalic acid to adipic acid was 93/7, the molar ratio of the hydroxyl group to the carboxyl group was 1.2, and 500 ppm of titanium tetraisopropoxide was added to the total amount of monomers. Then, the resultant was allowed to react at 230° C. for about 8 hours, and was allowed to react under reduced pressure of from 10 mm Hg through 15 mm Hg for 4 hours. After 1 mol % of trimellitic anhydride was added to the total amount of monomers, the resultant was allowed to react at 180° C. for 3 hours, to obtain [amorphous polyester resin B]. The [amorphous polyester resin B] had a glass transition temperature of 67° C. and a weight average molecular weight of 10,000.

### (Synthesis of Crystalline Polyester Resin C)

A reaction vessel equipped with a nitrogen-introducing tube, a dewatering tube, a stirrer, and a thermocouple was charged with sebacic acid and 1,6-hexanediol. At this time, the molar ratio of the hydroxyl group to the carboxyl group was 0.9, and 500 ppm of titanium tetraisopropoxide was added to the total amount of monomers. After the resultant was allowed to react at 180° C. for 10 hours, it was heated to 200° C. and was allowed to react for 3 hours. The resultant was further allowed to react under reduced pressure of 8.3 kPa for 2 hours, to obtain [crystalline polyester resin C]. The [crystalline polyester resin C] had a melting point of 67° C. and a weight average molecular weight of 25,000.

### Example 1

### <Preparation of Master Batch 1>

Water (1,500 parts), 500 parts of carbon black Printex 35 (obtained from Degussa) (DBP oil absorption amount: 42 mL/100 mg, pH: 9.5) as a colorant, and 500 parts of the [amorphous polyester resin B] were mixed using a Henschel mixer (obtained from NIPPON COKE & ENGINEERING COMPANY, LIMITED), and were kneaded using a twin-roller at 150° C. for 30 minutes. Then, the resultant was rolled and cooled, and was pulverized using a pulverizer, to obtain [master batch 1].

### <Synthesis of Wax Dispersion Agent 1>

An autoclave reaction tank equipped with a thermometer and a stirrer was charged with 480 parts of xylene and 100 parts of SANWAX 151P (obtained from Sanyo Chemical Industries, Ltd.) (melting point: 108° C., weight average molecular weight: 1000, polyethylene). Then, polyethylene was dissolved therein, and the resultant was purged with nitrogen. While a mixture liquid of styrene (805 parts), acrylonitrile (50 parts), butyl acrylate (45 parts), di-t-butyl peroxide (36 parts), and xylene (100 parts) was added dropwise for 3 hours, it was allowed to polymerize at 170° C. and was retained for 30 minutes. The solvent was removed to obtain [wax dispersion agent 1]. The [wax dispersion agent 1] had a glass transition temperature of 65° C. and a weight average molecular weight of 18,000.

### <Preparation of Wax Dispersion Liquid 1>

A vessel equipped with a stirring rod and a thermometer was charged with 300 parts of paraffin wax HNP-9 (obtained from Nippon Seiro Co., Ltd.) (melting point: 75° C.) as a release agent, 150 parts of the [wax dispersion agent 1], and 1,800 parts of ethyl acetate. Then, the resultant was heated to 80° C. under stirring and was retained for 5 hours, followed by cooling it to 30° C. for an hour. Using a bead mill, ULTRA VISCO MILL (obtained from AIMEX CO., LTD), zirconia beads with a diameter of 0.5 mm were packed in an amount of 80% by volume and were dispersed under the three-pass condition, to obtain [wax dispersion liquid 1]. At this time, the liquid feeding speed was set to 1 kg/h, and the circumferential speed of the disc was set to 6 m/s.

### <Preparation of Crystalline Polyester Resin Dispersion Liquid 1>

A vessel equipped with a stirring rod and a thermometer was charged with 308 parts of the [crystalline polyester resin C] and 1,900 parts of ethyl acetate. The resultant was heated to 80° C. under stirring, was retained for 5 hours, and was cooled to 30° C. for an hour. Using a bead mill, ULTRA VISCO MILL (obtained from AIMEX CO., LTD), zirconia beads with a diameter of 0.5 mm were packed in an amount of 80% by volume and were dispersed under the three-pass condition, to obtain [crystalline polyester resin dispersion liquid 1]. At this time, the liquid feeding speed was set to 1 kg/h, and the circumferential speed of the disc was set to 6 m/s.

### <Synthesis of Vinyl-Based Resin Dispersion Liquid 1>

A reaction vessel equipped with a stirring rod and a thermometer was charged with 683 parts of water, 11 parts of a sulfate sodium salt of a methacrylic acid ethylene oxide adduct ELEMINOL RS-30 (obtained from Sanyo Chemical Industries, Ltd.), 138 parts of styrene, 138 parts of methacrylic acid, and 1 part of ammonium persulfate, followed by stirring at 400 rpm for 15 minutes, to obtain a white emulsion. Then, the temperature in the system was heated to 75° C., and was allowed to react for 5 hours. A 1% ammonium persulfate aqueous solution (30 parts) was added thereto, and was aged at 75° C. for 5 hours, to obtain [vinyl-based resin dispersion liquid 1]. The [vinyl-based resin dispersion liquid 1] had a volume average particle diameter of 0.14 μm.

The volume average particle diameter of the [vinyl-based resin dispersion liquid 1] was measured using a laser diffraction/scattering type particle diameter distribution measuring device LA-920 (obtained from HORIBA).

### (Method for Producing Hydrophobic Silica Aggregated Particles)

First, 30 parts of hydrophobic silica A with an average particle diameter of 53 nm was added to 100 parts of ethanol, and ultrasonic waves were applied thereto using an ultrasonic homogenizer (product name: HOMOGENIZER, model: VCX750, CV33, obtained from SONICS & MATERIALS) for 5 minutes. After that, the resultant was subjected to centrifugal separation using a centrifugal separator (H2000B, obtained from KOKUSAN CO. Ltd) at 20,000 rpm for 60 minutes. The precipitated hydrophobic silica A was taken out and was dried at 100° C. for an hour, to obtain hydrophobic silica aggregates. The obtained hydrophobic silica aggregates were pulverized using an opposed jet mill (obtained from HOSOKAWA MICRON CORPORATION) as a pulverizer, to obtain hydrophobic silica aggregated particles, [hydrophobic silica A-1].

### <Preparation of Oil Phase 1>

A vessel was charged with 500 parts of the [wax dispersion liquid 1], 705 parts of the [crystalline polyester resin dispersion liquid 1], 228 parts of the [amorphous polyester prepolymer A], 836 parts of the [amorphous polyester resin B], 100 parts of the [master batch 1], 10 parts of the [inorganic filler (trimethylstearylammonium-modified montmorillonite)], and 2 parts of the [ketamine compound 1] as a curing agent, followed by mixing at 5,000 rpm for 60 minutes using a TK homomixer (obtained from Tokushu Kika Kogyo), to obtain [oil phase 1].

### <Preparation of Aqueous Phase 1>

Pure water (810 parts), 83 parts of the [vinyl-based resin dispersion liquid 1], 37 parts of a 48.5% aqueous solution of sodium dodecyl diphenyl ether disulfonate (ELEMINOL MON-7) (obtained from Sanyo Chemical Industries, Ltd.), 180 parts of sodium sulfate, and 90 parts of ethyl acetate were mixed and stirred, to obtain [aqueous phase 1] with milky white color.

### <Emulsification—Solvent Removal>

To the vessel, to which 800 parts of the [oil phase 1] had been added, 0.2 parts of the [ketamine 1] and 1,200 parts of the [aqueous phase 1] were added and were mixed using a TK homomixer at 13,000 rpm for 20 minutes, to obtain [emulsified slurry 1]. Then, a vessel equipped with a stirrer and a thermometer was charged with the [emulsified slurry 1], and the solvent was removed at 30° C. for 8 hours, followed by aging at 45° C. for 4 hours, to obtain [dispersed slurry 1].

Note that, [amorphous polyester A] was produced in the process of producing the toner base particles.

### <Washing⋅Heating⋅Drying>

The [dispersed slurry 1] (100 parts) was filtrated under reduced pressure. Then, 100 parts of ion exchanged water was added to the filtration cake. The resultant was mixed using a TK homomixer at 12,000 rpm for 10 minutes, and was filtrated (hereinafter, referred to as “washing step (1)”). A 10% sodium hydroxide aqueous solution (100 parts) was added to the filtration cake, and was mixed using a TK homomixer at 12,000 rpm for 30 minutes, followed by filtrating under reduced pressure (hereinafter, referred to as “washing step (2)”). Then, 10% hydrochloric acid (100 parts) was added to the filtration cake, and was mixed using a TK homomixer at 12,000 rpm for 10 minutes, followed by filtrating (hereinafter, referred to as “washing step (3)”). Moreover, 300 parts of ion exchanged water was added to the filtration cake, and was mixed using a TK homomixer at 12,000 rpm for 10 minutes, followed by filtrating (hereinafter, referred to as “washing step (4)”). At this time, the operation of the washing steps (1) to (4) was repeated twice.

Ion exchanged water (100 parts) was added to the filtration cake and was mixed using a TK homomixer at 12,000 rpm for 10 minutes. The resultant was heated at 50° C. for 4 hours, followed by filtrating. The filtration cake was dried at 45° C. for 48 hours using a circulator dryer and was sieved through a mesh with an opening of 75 μm. to obtain [toner base particles 1].

### <Addition of External Additive>

A Henschel mixer (obtained from Mitsui Mining Co., Ltd.) was used to mix 100 parts of the [toner base particles 1], 2.0 parts of the [hydrophobic silica A-1], 0.5 parts of hydrophobic titanium oxide fine particles with an average primary particle diameter of 20 nm (JMT-150IB, TAYCA CORPORATION), and 1.0 part of hydrophobic silica fine particles with an average primary particle diameter of 15 nm (HDK-2000, obtained from Wacker Chemie), to obtain [toner 1] of the present disclosure.

### Example 2

[Toner 2] of the present disclosure was obtained in the same manner as in Example 1 except that 7 parts of the [inorganic filler (trimethylstearylammonium-modified montmorillonite)] was added in the method for producing the oil phase in Example 1.

### Example 3

[Toner 3] of the present disclosure was obtained in the same manner as in Example 1 except that 12 parts of the [inorganic filler (trimethylstearylammonium-modified montmorillonite)] was added in the method for producing the oil phase in Example 1.

### Example 4

[Toner 4] of the present disclosure was obtained in the same manner as in Example 1 except that 880 parts of the [crystalline polyester resin dispersion liquid 1] was added in the method for producing the oil phase in Example 1.

### Example 5

[Toner 5] of the present disclosure was obtained in the same manner as in Example 1 except that 530 parts of the [crystalline polyester resin dispersion liquid 1] was added in the method for producing the oil phase in Example 1.

### Example 6

[Toner 6] of the present disclosure was obtained in the same manner as in Example 1 except that 880 parts of the [crystalline polyester resin dispersion liquid 1] and 7 part of the [inorganic filler (trimethylstearylammonium-modified montmorillonite) were added in the method for producing the oil phase in Example 1.

### Example 7

[Toner 7] of the present disclosure was obtained in the same manner as in Example 1 except that 5 parts of the [inorganic filler (trimethylstearylammonium-modified montmorillonite)] was added in the method for producing the oil phase in Example 1.

### Example 7

[Toner 8] of the present disclosure was obtained in the same manner as in Example 1 except that 18 parts of the [inorganic filler (trimethylstearylammonium-modified montmorillonite)] was added in the method for producing the oil phase in Example 1, and the number of revolutions of the TK homomixer was changed to 11,000 rpm in the emulsification step.

### Example 9

[Toner 9] of the present disclosure was obtained in the same manner as in Example 1 except that 530 parts of the [crystalline polyester resin dispersion liquid 1] and 12 parts of the [inorganic filler (trimethylstearylammonium-modified montmorillonite)] were added in the method for producing the oil phase in Example 1, and the number of revolutions of the TK homomixer was changed to 11,000 rpm in the emulsification step.

### Comparative Example 1

[Toner 10] of the present disclosure was obtained in the same manner as in Example 1 except that 15 parts of the [inorganic filler (trimethylstearylammonium-modified montmorillonite)] was added in the method for producing the oil phase in Example 1.

### Comparative Example 2

[Toner 11] of the present disclosure was obtained in the same manner as in Example 1 except that 350 parts of the [crystalline polyester resin dispersion liquid 1] and 5 parts of the [inorganic filler (trimethylstearylammonium-modified montmorillonite)] were added in the method for producing the oil phase in Example 1.

### Comparative Example 3

[Toner 12] of the present disclosure was obtained in the same manner as in Example 1 except that 350 parts of the [crystalline polyester resin dispersion liquid 1] and 7 parts of the [inorganic filler (trimethylstearylammonium-modified montmorillonite)] were added in the method for producing the oil phase in Example 1.

### Comparative Example 4

[Toner 13] of the present disclosure was obtained in the same manner as in Example 1 except that 350 parts of the [crystalline polyester resin dispersion liquid 1] and 18 parts of the [inorganic filler (trimethylstearylammonium-modified montmorillonite)] were added in the method for producing the oil phase in Example 1.

### Comparative Example 5

[Toner 14] of the present disclosure was obtained in the same manner as in Example 1 except that the [inorganic filler (trimethylstearylammonium-modified montmorillonite)] was not added in the method for producing the oil phase in Example 1.

### [Measurement—Evaluation]

The above toner 1 to toner 14 obtained were evaluated for toner physical properties through the following measurement⋅evaluation methods.

### <Volume Average Particle Diameter>

COULTER MULTISIZER 11 (obtained from Beckman Coulter) was used to measure the volume average particle diameter of the toner. In 100 mL to 150 mL of an electrolytic aqueous solution, 0.1 mL to 5 mL of a surfactant (preferably polyoxyethylene alkyl ether (nonionic surfactant)) was added as a dispersing agent. Here, the electrolytic aqueous solution was 1% by mass NaCl aqueous solution prepared using sodium chloride (first grade), and, for example, ISOTON-II (obtained from Coulter) can be used. Moreover, 2 mg to 20 mg of the measurement sample was added thereto. The electrolytic aqueous solution in which the sample had been suspended was subjected to a dispersion treatment for about 1 minute to 3 minutes using an ultrasonic dispersing machine. The particle diameter and the number of toners were measured using a 100 μm aperture of the measurement device, to determine a volume average particle diameter Dv.

Thirteen channels (2.00 μm or more but less than 2.52 μm; 2.52 μm or more but less than 3.17 μm; 3.17 μm or more but less than 4.00 μm; 4.00 μm or more but less than 5.04 μm; 5.04 μm or more but less than 6.35 μm; 6.35 μm or more but less than 8.00 μm; 8.00 μm or more but less than 10.08 μm; 10.08 μm or more but less than 12.70 μm; 12.70 μm or more but less than 16.00 μm; 16.00 μm or more but less than 20.20 μm; 20.20 μm or more but less than 25.40 μm: 25.40 μm or more but less than 32.00 μm; and 32.00 μm or more but less than 40.30 μm) were used. Particles having a particle diameter of 2.00 μm or more but less than 40.30 m were targeted.

### <Average Circularity>

The wet flow-type particle diameter⋅shape analyzing device FPIA-2100 and analyzing software FPIA-2100 Data Processing Program for FPIA version 00-10 (obtained from SYSMEX CORPORATION) were used to measure the average circularity of the toner. Specifically, a 10% aqueous solution of alkyl is benzene sulfonate NEOGEN SC-A (obtained from DKS Co. Ltd.) (from 0.1 mL to 0.5 mL) and the toner (from 0.1 g to 0.5 g) were added to a 100 mL-glass beaker, and were stirred using a microspatula. Then, 80 mL of ion exchanged water was added thereto. Using an ultrasonic wave disperser UH-50 (obtained from SMT), under the following conditions: 20 kHz and 50 W/10 cm³, the resultant was dispersed for a minute, followed by dispersing for 5 minutes in total, to obtain a measurement sample. The measurement sample with a particle concentration of from 4,000 to 8,000/10⁻³ cm³ was used to measure an average circularity of particles having an equivalent circle diameter of 0.60 μm or more but less than 159.21 μm.

### (Determination of Surface Roughness Parameter Sz)

Using analyzing software NanoScope Analysis (Bruker), the surface roughness parameter Sz can be determined by analyzing three-dimensional data obtained from the surface measurement with an atomic force microscope (AFM). Specifically, the PlaneFit function that uses the linear equation corrects the slope of the three-dimensional data. Next, the PlaneFit function that uses the quadratic equation removes information on the particle shape of the toner. Then, the Roughness function is used to calculate a surface roughness parameter. Regarding a region in which the surface roughness parameter is to be calculated, the region to be analyzed is appropriately adjusted so that the region does not include a region other than a toner particle.

### <Dispersion Condition of Filler>

The dispersion condition of the inorganic filler of the toner base particles was observed with a scanning electron microscope (SU8230, obtained from Hitachi High-Tech Corporation). The observation was performed in the backscattered electron image mode at an acceleration voltage of 0.8 kV. In the backscattered electron image, the inorganic filler can be observed as a high brightness contrast part.

The photographed backscattered electron image was binarized using image processing software to determine an area S1 of the whole toner base particles. The high brightness contrast part of the inorganic filler was binarized as well to determine the area distribution. From the area distribution of the high brightness contrast part, the standard deviation and a total area S2 of the inorganic filler were determined.

### <Evaluation of Cleanability>

The toners of Examples and Comparative Examples were used to produce 50,000 charts having an image area ratio of 5% (A4 size, landscape orientation) using a modified color multifunction peripheral RICOH MPC3504 (obtained from RICOH Company, Ltd.) under the environment of 23° C. and 53% RH. Then, 100 longitudinal band charts (A4 size, landscape orientation) were outputted under the environment of 32° C. and 54% RH. The obtained images were visually observed to evaluate them as to presence or absence of abnormal images due to cleaning failure.

### [Evaluation Criteria]

A: The toner that had slipped due to cleaning failure was visually observed neither on print paper nor on a photoconductor, and stripe-shaped marks of the toner that had slipped were not found even when the photoconductor was observed in a longitudinal direction with a microscope.

B: The toner that had slipped due to cleaning failure was visually observed neither on print paper nor on a photoconductor, but stripe-shaped marks of the toner that had slipped were slightly found when the photoconductor was observed in a longitudinal direction with a microscope.

C: The toner that had slipped due to cleaning failure was visually and slightly found on a photoconductor, but was not confirmed on print paper.

D: The toner that had slipped due to cleaning failure was visually observed both on print paper and on a photoconductor.

### <Evaluation of Transferability>

Using an evaluation machine, which was obtained by modifying DocuColor 8000 Digital Press (obtained from FUJI XEROX) and tuning the linear velocity to 162 mm/sec and the transfer time to 40 msec, each developer was subjected to a running test. The running test was performed using output test images of solid patterns with a size of A4 and a toner deposition amount of 0.6 mg/cm². At the initial stage of the test image and after 100 K output, the primary transfer efficiency was determined from the following Formula (1), and the secondary transfer efficiency was determined from the following Formula (2).

$$Primary transfer efficiency ( \% ) = \frac{\begin{matrix}Amount of toner transferred \\ to intermediate transfer member\end{matrix}}{\begin{matrix}Amount of toner developed \\ on electrostatic latent image bearer\end{matrix}} ⨯ 100 \qquad Formula ( 1 )$$

$$Secondary transfer efficiency ( \% ) = \frac{\begin{matrix}Amount of toner transferred \\ to intermediate transfer member - \\ \begin{matrix}Amount of toner remaining on intermediate \\ transfer member after transferring\end{matrix}\end{matrix}}{\begin{matrix}Amount of toner transferred \\ to intermediate transfer member\end{matrix}} ⨯ 100 \qquad Formula ( 2 )$$

As the evaluation criteria, an average value of the primary transfer efficiency and the secondary transfer efficiency was calculated and was evaluated based on the following criteria.

### [Evaluation Criteria]

A: 90% or more

B: 85% or more but less than 90%

C: 80% or more but less than 85%

D: Less than 80%

The evaluation criteria of Examples 1 to 9 and Comparative Examples 1 to 5 were provided in Table 1. From Table 1, the toners of the present disclosure in Examples 1 to 9 were found to have good results on the cleanability and the transferability.

TABLE 1

| | | | Endothermic | Amount of | | Volume | | | | | |
|---|---|---|---|---|---|---|---|---|---|---|---|
| | | | peak | inorganic | | average | | | | | |
| | | | endothermic | filler | | particle | | | | | |
| | | | amount | [% by | | diameter | Average | S₂ | | | Over-all |
| | Toner | Method | [J/g] | mass] | S2/S1 | (μm) | circularity | [nm] | Transferability | Cleanability | evaluation |
| Ex. 1 | Toner 1 | Polymerization | 8.1 | 0.8 | 0.5 | 5.3 | 0.980 | 320 | B | B | B |
| | | method | | | | | | | | | |
| Ex. 2 | Toner 2 | Polymerization | 8.1 | 0.6 | 0.4 | 5.2 | 0.983 | 301 | A | C | B |
| | | method | | | | | | | | | |
| Ex. 3 | Toner 3 | Polymerization | 7.9 | 1.0 | 0.6 | 5.3 | 0.977 | 384 | C | B | B |
| | | method | | | | | | | | | |
| Ex. 4 | Toner 4 | Polymerization | 10.2 | 0.8 | 0.7 | 5.5 | 0.978 | 453 | B | B | B |
| | | method | | | | | | | | | |
| Ex. 5 | Toner 5 | Polymerization | 4.3 | 0.8 | 0.3 | 5.2 | 0.981 | 245 | B | B | B |
| | | method | | | | | | | | | |
| Ex. 6 | Toner 6 | Polymerization | 10.5 | 0.6 | 0.6 | 5.2 | 0.982 | 423 | B | B | B |
| | | method | | | | | | | | | |
| Ex. 7 | Toner 7 | Polymerization | 4.2 | 0.6 | 0.2 | 5.5 | 0.985 | 211 | A | C | B |
| | | method | | | | | | | | | |
| Ex. 8 | Toner 8 | Polymerization | 13.9 | 1.0 | 0.8 | 4.9 | 0.974 | 489 | C | A | B |
| | | method | | | | | | | | | |
| Ex. 9 | Toner 9 | Polymerization | 4.3 | 1.0 | 0.4 | 5.4 | 0.978 | 233 | B | B | B |
| | | method | | | | | | | | | |
| Comp. | Toner 10 | Polymerization | 8.3 | 1.2 | 0.7 | 5.7 | 0.973 | 399 | D | A | D |
| Ex. 1 | | method | | | | | | | | | |
| Comp. | Toner 11 | Polymerization | 7.9 | 0.4 | 0.2 | 5.3 | 0.986 | 201 | A | D | D |
| Ex. 2 | | method | | | | | | | | | |
| Comp. | Toner 12 | Polymerization | 1.8 | 0.6 | 0.1 | 5.6 | 0.982 | 149 | A | D | D |
| Ex. 3 | | method | | | | | | | | | |
| Comp. | Toner 13 | Polymerization | 1.6 | 1.5 | 0.9 | 5.2 | 0.978 | 591 | D | B | D |
| Ex. 4 | | method | | | | | | | | | |
| Comp. | Toner 14 | Polymerization | 8.1 | 0 | 0 | 5.2 | 0.986 | 198 | A | D | D |
| Ex. 5 | | method | | | | | | | | | |

The invention of the present disclosure is the toner according to the following (1), and also includes the embodiments of the inventions according to the following (2) to (10).

(1) A toner including:

toner base particles including a binder resin, a colorant, an inorganic filler, and a release agent; and

an external additive,

wherein an average circularity of the toner is 0.974 or more but 0.985 or less, and

a surface roughness parameter Sz of a surface of the toner is 200 nm or more but 500 nm or less, the surface roughness parameter Sz being measured with an atomic force microscope (AFM).

(2) The toner according to (1),

wherein the average circularity of the toner is 0.978 or more but 0.982 or less.

(3) The toner according to (1) or (2),

wherein the surface roughness parameter Sz of the surface of the toner is 300 nm or more but 400 nm or less.

(4) The toner according to any one of (1) to (3),

wherein the inorganic filler is a layered inorganic mineral including an Al element, and

part of ions between layers of the layered inorganic mineral is modified with organic ions.

(5) The toner according to any one of (1) to (4),

wherein a volume average particle diameter of the toner is 4.0 μm or more but less than 6.0 μm, and

a formula: 0.30≤S2/S1≤0.70 is satisfied, where the S1 is an area of the toner base particles, and the S2 is a total area of the inorganic filler exposed on surfaces of the toner base particles in a backscattered electron image of the toner base particles taken with a scanning electron microscope.

(6) The toner according to any one of (1) to (5),

wherein an endothermic amount of an endothermic peak of the toner is from 4.0 J/g through 14.0 J/g, and the endothermic amount of the endothermic peak is derived from a crystalline polyester resin of the toner at a first heating in differential scanning calorimetry (DSC).

(7) A developer including:

the toner according to any one of (1) to (6); and

a carrier.

(8) An image forming method including:

charging a surface of an electrostatic latent image bearer;

exposing the surface of the electrostatic latent image bearer charged to light to form an electrostatic latent image on the electrostatic latent image bearer;

developing, with the toner according to any one of (1) to (6), the electrostatic latent image formed on the electrostatic latent image bearer to form a toner image;

transferring the toner image to an intermediate transfer member;

transferring, to a recording medium, the toner image transferred to the intermediate transfer member;

fixing the toner image transferred to the recording medium; and

removing the toner remaining on the electrostatic latent image bearer after the transferring or the toner remaining on the intermediate transfer member after the transferring, or both.

(9) An image forming apparatus including:

an electrostatic latent image bearer;

a charging unit configured to charge the electrostatic latent image bearer;

an exposing unit configured to expose the electrostatic latent image bearer charged to light to form an electrostatic latent image;

a developing unit that includes the toner according to any one of (1) to (6) and is configured to develop, with the toner, the electrostatic latent image formed on the electrostatic latent image bearer to form a toner image;

a transferring unit configured to transfer, to an intermediate transfer member, the toner image formed on the electrostatic latent image bearer;

a transferring unit configured to transfer, to a surface of a recording medium, the toner image transferred to the intermediate transfer member;

a fixing unit configured to fix the toner image transferred to the surface of the recording medium; and

a cleaning unit configured to remove the toner remaining on the electrostatic latent image bearer after the transferring or a cleaning unit configured to remove the toner remaining on the intermediate transfer member after the transferring, or both.

(10) A toner storage unit including:

a unit; and

the toner according to any one of (1) to (6) stored in the unit.

What is claimed is:

1. A toner comprising:
toner base particles including a binder resin, a colorant, an inorganic filler, and a release agent; and
an external additive,
wherein an average circularity of the toner is 0.974 or more but 0.985 or less, and
a surface roughness parameter Sz of a surface of the toner is 200 nm or more but 500 nm or less, the surface roughness parameter Sz being measured with an atomic force microscope (AFM).

2. The toner according to claim 1,
wherein the average circularity of the toner is 0.978 or more but 0.982 or less.

3. The toner according to claim 1,
wherein the surface roughness parameter Sz of the surface of the toner is 300 nm or more but 400 nm or less.

4. The toner according to claim 1,
wherein the inorganic filler is a layered inorganic mineral including an Al element, and
part of ions between layers of the layered inorganic mineral is modified with organic ions.

5. The toner according to claim 1,
wherein a volume average particle diameter of the toner is 4.0 μm or more but less than 6.0 μm, and
a formula: 0.30≤S2/S1≤0.70 is satisfied, where the S1 is an area of the toner base particles, and the S2 is a total area of the inorganic filler exposed on surfaces of the toner base particles in a backscattered electron image of the toner base particles taken with a scanning electron microscope.

6. The toner according to claim 1,
wherein an endothermic amount of an endothermic peak of the toner is from 4.0 J/g through 14.0 J/g, and the endothermic amount of the endothermic peak is derived from a crystalline polyester resin of the toner at a first heating in differential scanning calorimetry (DSC).

7. A developer comprising:
the toner according to claim 1; and
a carrier.

8. An image forming method comprising:
charging a surface of an electrostatic latent image bearer;
exposing the surface of the electrostatic latent image bearer charged to light to form an electrostatic latent image on the electrostatic latent image bearer;
developing, with the toner according to claim 1, the electrostatic latent image formed on the electrostatic latent image bearer to form a toner image;
transferring the toner image to an intermediate transfer member;
transferring, to a recording medium, the toner image transferred to the intermediate transfer member;
fixing the toner image transferred to the recording medium; and
removing the toner remaining on the electrostatic latent image bearer after the transferring or the toner remaining on the intermediate transfer member after the transferring, or both.

9. An image forming apparatus comprising:
an electrostatic latent image bearer;
a charging unit configured to charge the electrostatic latent image bearer;
an exposing unit configured to expose the electrostatic latent image bearer charged to light to form an electrostatic latent image;
a developing unit that includes the toner according to claim 1 and is configured to develop, with the toner, the electrostatic latent image formed on the electrostatic latent image bearer to form a toner image;
a transferring unit configured to transfer, to an intermediate transfer member, the toner image formed on the electrostatic latent image bearer;
a transferring unit configured to transfer, to a surface of a recording medium, the toner image transferred to the intermediate transfer member;
a fixing unit configured to fix the toner image transferred to the surface of the recording medium; and
a cleaning unit configured to remove the toner remaining on the electrostatic latent image bearer after the transferring or a cleaning unit configured to remove the toner remaining on the intermediate transfer member after the transferring, or both.

10. A toner storage unit comprising:
a unit; and
the toner according to claim 1 stored in the unit.
